(19) United States
(12) Patent Application Publication
(10) Pub. No.: US 2026/0292492 A1
(43) Pub. Date: Sep. 24, 2026

(54) SUPPORTING REMOTE UNIT REAUTHENTICATION

(71) Applicant: Lenovo (Singapore) Pte. Ltd., Singapore (SG)

(72) Inventors: Andreas Kunz, Ladenburg (DE); Apostolis Salkintzis, Athens (GR); Sheeba Backia Mary Baskaran, Friedrichsdorf (DE)

(21) Appl. No.: 19/680,907

(22) Filed: May 18, 2026

Related U.S. Application Data
(63) Continuation of application No. 18/008,408, filed on Jun. 5, 2020, now Pat. No. 12,659,735.

(51) Int. Cl. H04W 12/06; H04L 9/40; H04W 12/041; H04W 12/0433; H04W 12/084; H04W 12/086

(52) U.S. Cl. CPC H04W 12/06; H04L 63/164; H04W 12/041; H04W 12/0433; H04W 12/084; H04W 12/086

(57) ABSTRACT

Apparatuses, methods, and systems are disclosed for supporting user equipment (“UE”) reauthentication. One apparatus includes a processor coupled with at least one memory and configured to receive, from a gateway function, a key management domain name associated with a reauthentication of a UE via a first management domain; receive a first authentication message for reauthenticating the UE; determine a management domain mismatch based on the first authentication message; reject the reauthentication of the UE in response to the determined management domain mismatch; and trigger an initial authentication with the UE in response to the rejected reauthentication.

The subject matter disclosed herein relates generally to supporting reauthentication for a user equipment (“UE”) with a Trusted Non-3GPP Gateway Function (“TNGF”).

### BACKGROUND

In certain embodiments, a UE may access a Fifth Generation (“5G”) core (“5GC”) network via a gateway function (e.g., TNGF) in a Trusted Non-3GPP Access Network (“TNAN”).

### BRIEF SUMMARY

One method of a UE, e.g., for supporting remote unit (e.g., UE) reauthentication, includes sending a first authentication message to a network function to authenticate a remote unit (e.g., a UE) with a mobile communication network and receiving a second authentication message from the network function in response to the first authentication message. Here, the first authentication message contains an indicator that the remote unit supports Extensible Authentication Protocol (“EAP”) Reauthentication Protocol (“ERP”), and the second authentication message contains a key management domain name (“KM-DN”), the KM-DN indicating a group of network functions that can share reauthentication security context for the apparatus to perform ERP. The method includes deriving reauthentication security context in response to successful authentication with the mobile communication network and locally storing the received KM-DN and the derived reauthentication security context for subsequent reauthentication with the mobile communication network.

One method of a TNGF, e.g., for supporting remote unit (e.g., UE) reauthentication, includes receiving a first authentication message for reauthenticating a remote unit (e.g., a UE). Here, the first authentication message includes a Network Access Identifier (“NAI”) containing a first username and a first domain name, where the first username comprises a key identifier. The method includes verifying the first domain name and validating the first authentication message using at least the reauthentication Integrity Key (“rIK”) from the security context identified by the first username. Here, the first domain name identifies a KM-DN and an associated gateway function holding the reauthentication security context. The method includes generating a second authentication message in response to successfully validating the first authentication message and responding to the first authentication message by sending the second authentication message.

One method of a target TNGF, e.g., for supporting remote unit (e.g., UE) reauthentication, includes receiving a first authentication message for reauthenticating a remote unit (e.g., a UE). Here, the first authentication message includes an NAI containing a first username and a first domain name, where the first username comprises a key identifier. The method includes verifying the first domain name and determining from the TNGF identification information indicated as part of the first domain name and first username that the reauthentication security context for the remote unit is held by a source gateway function. Here, the first domain name identifies a KM-DN and an associated gateway function holding a reauthentication security context. The method includes forwarding the first authentication message to the source gateway function and receiving the reauthentication security context from the source gateway function. The method includes generating a second authentication message in response to receiving the reauthentication security context and sending the second authentication message to the remote unit.

One method of a Trusted Non-3GPP Access Point (“TNAP”), e.g., for supporting remote unit (e.g., UE) reauthentication, includes receiving a first KM-DN from a gateway function during association between an access point and the gateway function, the KM-DN forwarded to a remote unit (e.g., a UE) for use in reauthentication. The method includes receiving a first authentication message for reauthenticating the remote unit and determining a KM-DN mismatch. Here, the first authentication message includes either a Key management domain name mismatch indicator or an NAI containing a first username and a first domain name, where the first domain name identifies a second KM-DN and an associated gateway function holding a reauthentication security context of the remote unit. The method includes rejecting reauthentication of the remote unit in response to the determined mismatch and triggering initial authentication with the remote unit in response to the rejected reauthentication.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings.

FIG. 1 illustrates an example of a wireless communication system for supporting remote unit (e.g., UE) reauthentication.

FIG. 2A illustrates an example signal flow of a 5G registration procedure over a trusted non-3GPP access network.

FIG. 2B is a continuation of the procedure depicted in FIG. 2A.

FIG. 2C is a continuation of the procedure depicted in FIG. 2B.

FIG. 3A illustrates an example signal flow of a first solution for remote unit (e.g., UE) reauthentication.

FIG. 3B is a continuation of the procedure depicted in FIG. 3A.

FIG. 4A illustrates an example signal flow of a second solution for remote unit (e.g., UE) reauthentication.

FIG. 4B is a continuation of the procedure depicted in FIG. 4A.

FIG. 4C is a continuation of the procedure depicted in FIG. 4B.

FIG. 5 illustrates an example signal flow of a third solution for remote unit (e.g., UE) reauthentication.

FIG. 6 illustrates an example of a user equipment apparatus that supports remote unit reauthentication.

FIG. 7 illustrates an example of a network equipment apparatus that supports remote unit reauthentication.

FIG. 8 illustrates an example of a first method for supporting remote unit (e.g., UE) reauthentication.

FIG. 9 illustrates an example of a second method for supporting remote unit (e.g., UE) reauthentication.

FIG. 10 illustrates an example of a third method for supporting remote unit (e.g., UE) reauthentication.

FIG. 11 illustrates an example of a fourth method for supporting remote unit (e.g., UE) reauthentication.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer-readable storage devices storing machine readable code, computer-readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer-readable medium may be utilized. The computer-readable medium may be a computer-readable storage medium. The computer-readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM”) or Flash memory, a portable compact disc read-only memory (“CD-ROM”), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures, including alternate embodiments of like elements.

Methods, apparatuses, and systems are disclosed for supporting remote unit (e.g., UE) reauthentication. A UE may access a 5GC network via a TNGF in a TNAN. When the UE wants to exchange Non-Access Stratum (“NAS”) messages with 5GC via a TNAN, an EAP for 5G access (“EAP-5G”) session is initiated between the UE and a TNGF, and NAS messages are transferred over the EAP-5G session. This enables the UE to perform various 5G NAS procedures via trusted non-3GPP access, such as a registration procedure and a service request procedure.

The EAP Reauthentication Protocol (“ERP”) is currently supported in communication networks to reauthenticate the UEs with the local EAP Reauthentication (“ER”) Server (based on the previously generated security context) if the UE attempts to reconnect to the same serving/home network. But the ERP currently does not support sharing of reauthentication security context among the ER Servers if there is a UE mobility between the ER Servers. Therefore, when the UE moves to an area served by a different ER Server, the UE must perform a full authentication with the core network causing unnecessary delay in the UE attachment time and complexity to the network.

The EAP Extensions for the ERP is specified in IETF RFC 6696. According to RFC 6696, the EAP is an authentication framework that supports multiple authentication methods.

The EAP keying hierarchy defines two keys to be derived by all key-generating EAP methods: the Master Session Key (“MSK”) and the Extended MSK (“EMSK”). In the most common deployment scenario, an EAP peer and an EAP server authenticate each other through a third party known as the EAP authenticator. The EAP authenticator or an entity controlled by the EAP authenticator enforces access control. When a peer moves from one authenticator to another, it is desirable to avoid a full EAP authentication to support fast handovers. The full EAP exchange with another run of the EAP method can take several round trips and significant time to complete, causing increased handover times. Key sharing across authenticators is sometimes used as a practical solution to lower handover times. In that case, however, the compromise of one authenticator results in the compromise of key material established via other authenticators.

To achieve low latency handovers, the disclosure specifies EAP Reauthentication Extensions (“ERXs”) for efficient reauthentication using EAP. The ERP supports reauthentication of a peer that has valid, unexpired key material from a previously performed EAP authentication, independently from the EAP authentication method used.

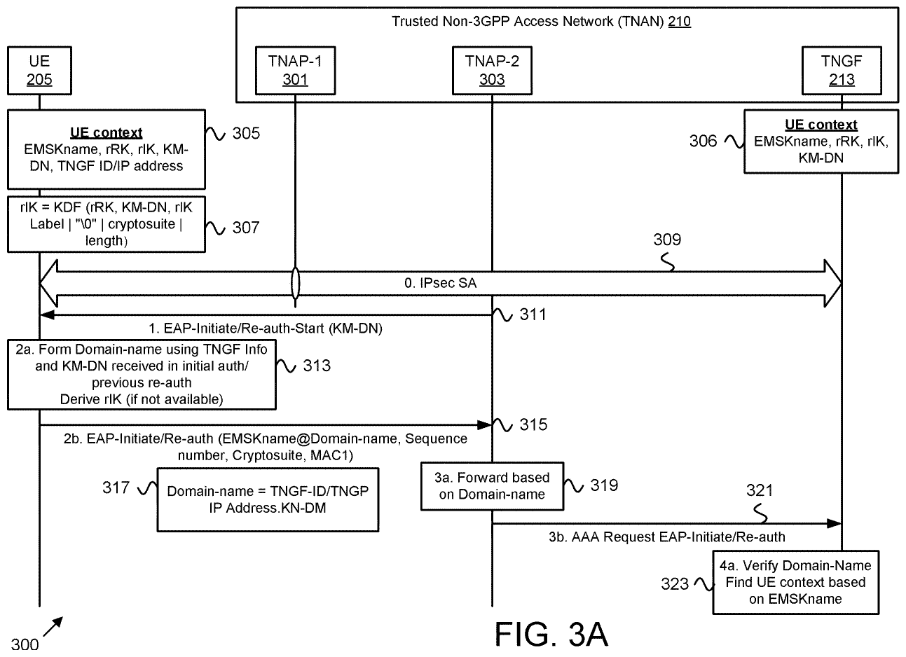

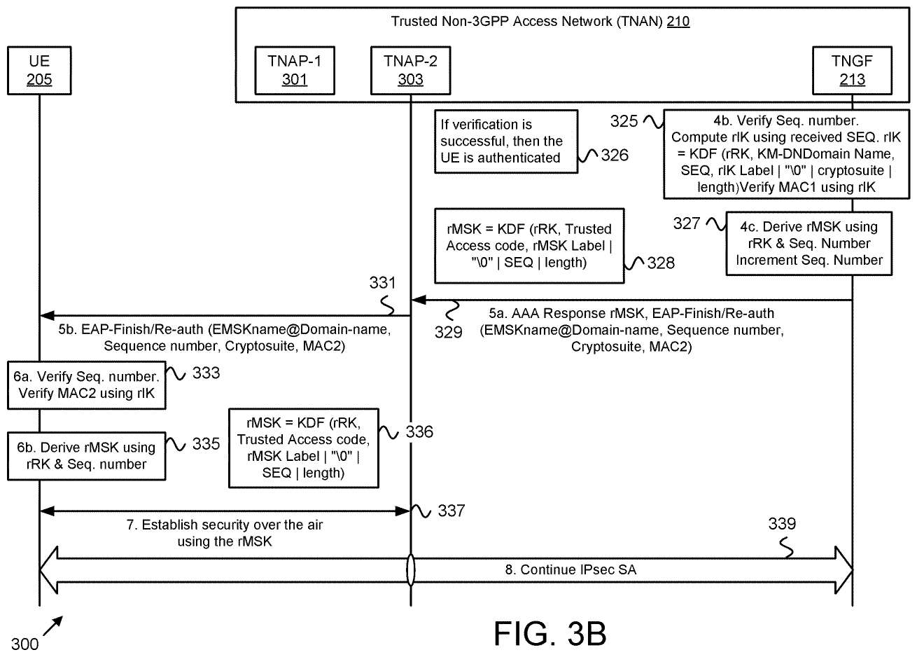

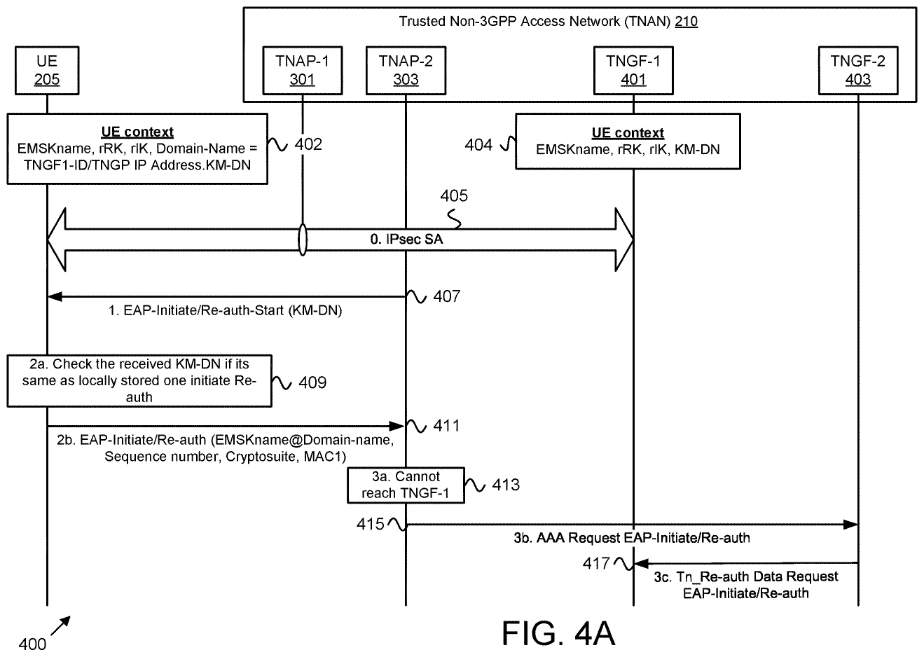

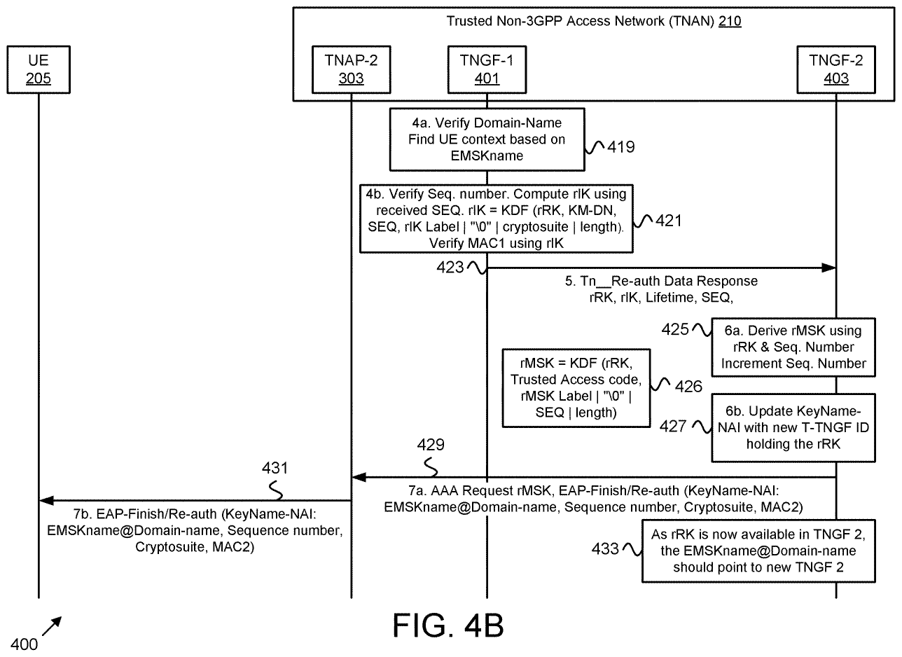

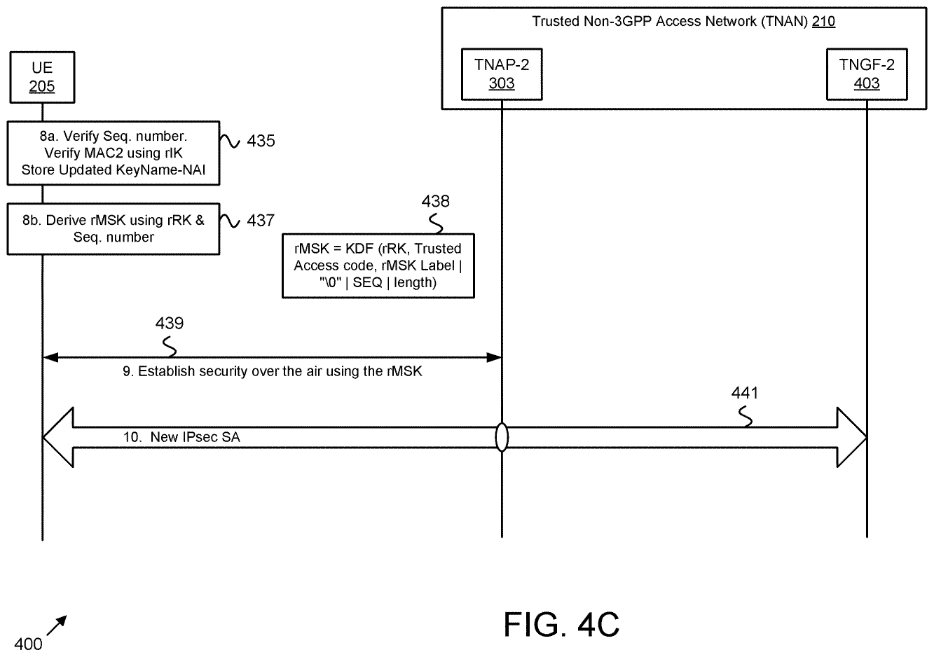

The ERP uses a Reauthentication Root Key (“rRK”), which is derived by the AUSF (EAP Server) from EMSK and provided to the TNGF by implicit bootstrapping during UE initial authentication. As discussed in further detail below, the rRK is used to derive a Reauthentication Integrity Key (“rIK”) and at least one Reauthentication Master Session Key (“rMSK”). In various embodiments, the ERP Keys are derived during the EAP exchange (i.e. during initial UE full authentication). Further, the ERP exchange for UE reauthentication is carried out between the UE, an ER Authenticator, and an ER Server, as discussed below with reference to FIGS. 3A-3B and 4A-4C.

When a UE moves from a source TNAP to a target TNAP within the area of the same TNGF, it does not need to perform a full authentication. Instead, the UE is reauthenticated by the TNGF (ER Server) and a fresh rMSK key is derived by the TNGF and provided to the Target/New TNAP to establish security over the air between UE and the Target TNAP. In the 5G system supporting ERP, the UE performs the role of peer, the TNAP performs the role of ER authenticator, and the TNGF performs the role of ER Server (i.e., Local ER Server). Note that in the 5G system, the AUSF takes the role of the backend authentication server (i.e., EAP Server).

The present disclosure describes solutions that support reauthentication during UE mobility between two TNGFs (ER Servers) and that mitigate security breach due to static rIK leakage by introducing dynamic rIK (also known as “fresh” rIK) for every ERP run to integrity protect ERP message exchanges. The present disclosure describes solutions that use key management domains to control sharing of UE's reauthentication security context among one or more TNGFs or TNANs, thereby reducing overhead caused by domain specific root reauthentication key (DSRK) which requires EAP Server involvement for reauthentication of UE for every instance of its mobility between the different ER Server domain leading to message exchange overhead.

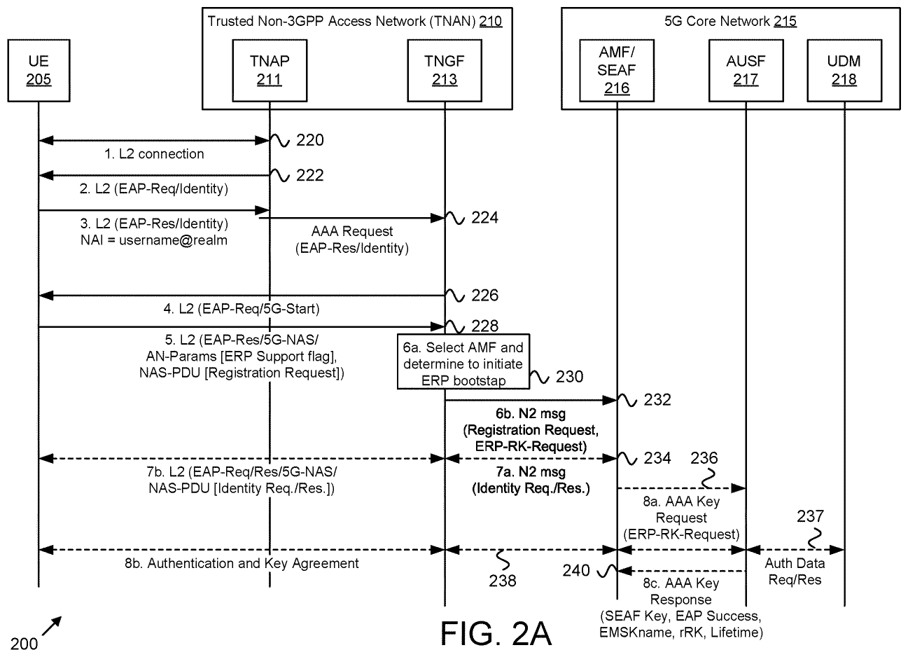

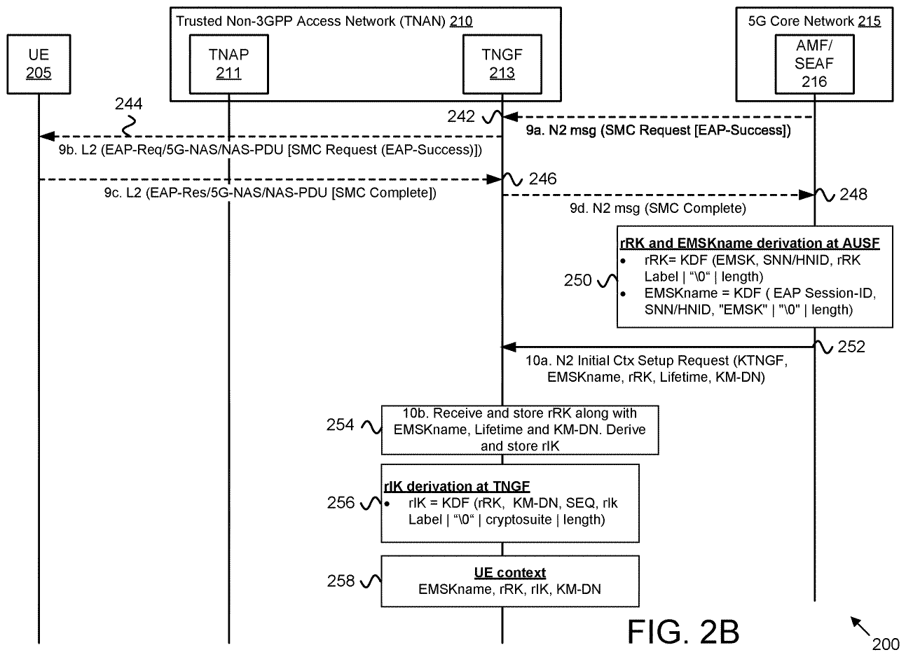

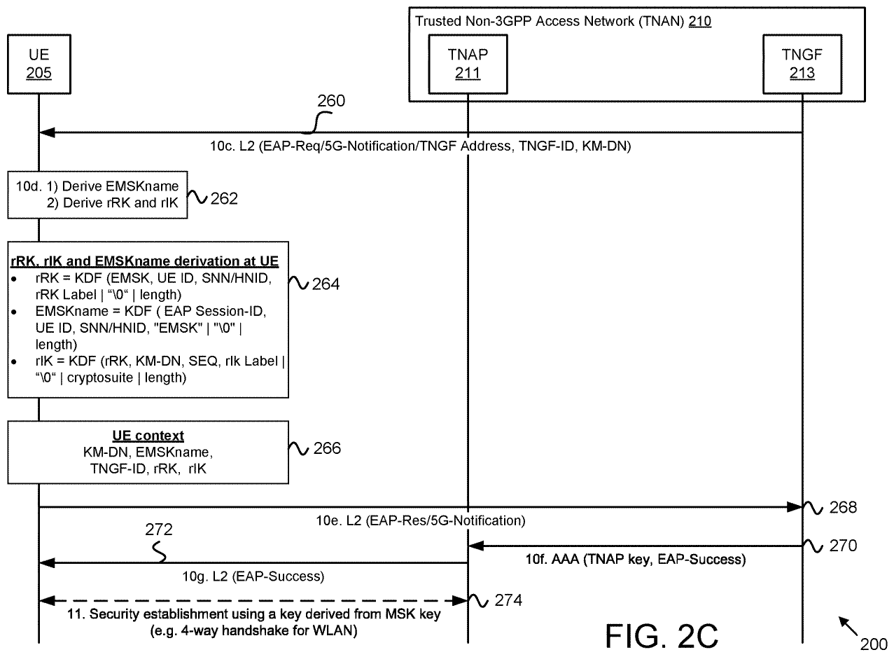

According to a first solution, the 5G system is enhanced to support reauthentication of UEs using trusted non-3GPP access in the 5G Network. The first solution consists of a first phase, described below with reference to FIGS. 2A-2C, and a second phase, described below with reference to FIGS. 3A-3B and 4A-4C. The first phase is an ERP implicit bootstrapping phase, which happens during the Initial full authentication. The second phase is a reauthentication phase using ERP. Note that the second phase considers two types of UE mobility: A) Intra-TNGF Reauthentication (UE mobility within same TNGF between two TNAPs) and B) Inter-TNGF Reauthentication (UE mobility between two TNGFs). Intra-TNGF reauthentication is described below with reference to FIGS. 3A-3B. Inter-TNGF reauthentication is described below with reference to FIGS. 4A-4C.

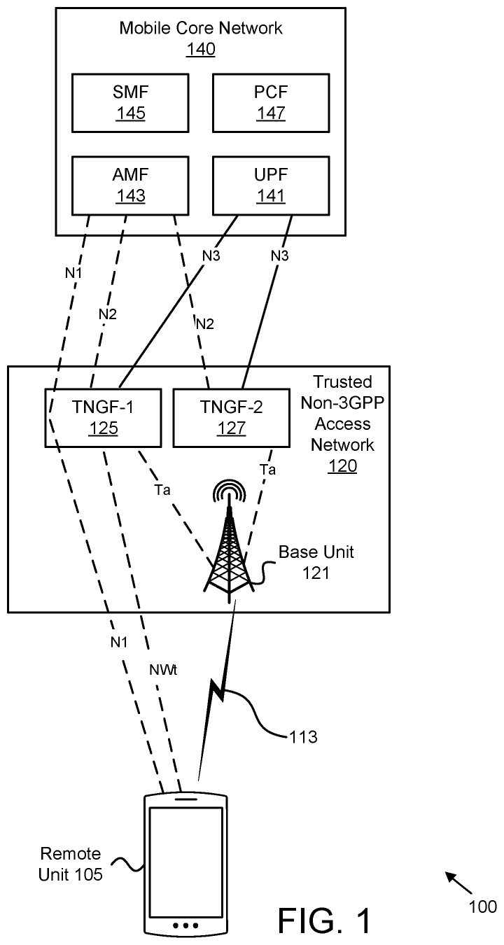

FIG. 1 depicts a wireless communication system 100 for supporting remote unit (e.g., UE) reauthentication, according to embodiments of the disclosure. In one embodiment, the wireless communication system 100 includes at least one remote unit 105, at least one TNAN 120, and a mobile core network 140 in a Public Land Mobile Network (“PLMN”). The TNAN 120 may be composed of at least one base unit 121. The remote unit 105 may communicate with the TNAN 120 using communication links 113 (e.g., to include one or more non-3GPP communication links), according to a radio access technology deployed by TNAN 120. Even though a specific number of remote units 105, base units 121, TNANs 120, and mobile core networks 140 are depicted in FIG. 1, one of skill in the art will recognize that any number of remote units 105, base units 121, TNANs 120, and mobile core networks 140 may be included in the wireless communication system 100.

In one implementation, the wireless communication system 100 is compliant with the 5G system specified in the Third Generation Partnership Project (“3GPP”) specifications. More generally, however, the wireless communication system 100 may implement some other open or proprietary communication network, for example, Long Term Evolution (“LTE”) and/or evolved packet core (“EPC”) (referred as ‘4G’) or Worldwide Interoperability for Microwave Access (“WiMAX”), among other networks. The present disclosure is not intended to be limited to the implementation of any particular wireless communication system, architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 121 in the TNAN 120 via uplink (“UL”) and downlink (“DL”) communication signals. Furthermore, the UL and DL communication signals may be carried over the communication links 113. Note, that the TNAN 120 is an intermediate network that provide the remote units 105 with access to the mobile core network 140.

The base units 121 may serve a number of remote units 105 within a serving area, for example, a cell or a cell sector, via a communication link 113. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the communication links 113. The communication links 113 may be any suitable carrier in licensed or unlicensed radio spectrum. The communication links 113 facilitate communication between one or more of the remote units 105 and/or one or more of the base units 121.

As noted above, the TNAN 120 supports secure signaling interfaces and interworking with the 5G core network. The TNAN includes at least one TNGF; in the depicted embodiment the TNAN 120 includes a first TNGF (denoted “TNGF-1”) 125 and a second TNGF (denoted “TNGF-2”) 127. In certain embodiments, the TNAN 120 supports a Tn interface between the TGNF in the TNAN 120.

The base units 121 may be distributed over a geographic region. In certain embodiments, a base unit 121 may also be referred to as a TNAP, an access terminal, an access point, a base, a base station, a relay node, a device, or by any other terminology used in the art. The base units 121 are generally part of a radio access network (“RAN”), such as the TNAN 120, that may include one or more controllers communicably coupled to one or more corresponding base units 121. These and other elements of radio access network are not illustrated but are well known generally by those having ordinary skill in the art. The base units 121 connect to the mobile core network 140 via the TNAN 120.

In some embodiments, the remote units 105 communicate with an application server (or other communication peer) via a network connection with the mobile core network 140. For example, an application in a remote unit 105 (e.g., web browser, media client, telephone (e.g., Voice-over-Internet-Protocol (“VoIP”)) application) may trigger the remote unit 105 to establish a Protocol Data Unit (“PDU”) session (or other data connection) with the mobile core network 140 using the TNAN 120. In order to establish the PDU session, the remote unit 105 must be registered with the mobile core network.

In one embodiment, the mobile core network 140 is a 5GC or the EPC, which may be coupled to a data network (such as the Internet and private data networks, among other data networks). A remote unit 105 may have a subscription or other account with the mobile core network 140. The present disclosure is not intended to be limited to the implementation of any particular wireless communication system, architecture or protocol.

The mobile core network 140 includes several network functions (“NFs”). As depicted, the mobile core network 140 includes at least one User Plane Function (“UPF”) 141. The mobile core network 140 also includes multiple control plane functions including, but not limited to, an Access and Mobility Management Function (“AMF”) 143, a Session Management Function (“SMF”) 145, and a Policy Control Function (“PCF”) 147. In certain embodiments, the mobile core network 140 may also include a Unified Data Management function (“UDM”) 149, an Authentication Server Function (“AUSF”), a Network Repository Function (“NRF”) (used by the various NFs to discover and communicate with each other over Application Programing Interfaces (“APIs”)), or other NFs defined for the 5GC.

In various embodiments, the mobile core network 140 supports different types of mobile data connections and different types of network slices, wherein each mobile data connection utilizes a specific network slice. Each network slice includes a set of control-plane and user-plane network functions, wherein each network slice is optimized for a specific type of service or traffic class. The different network slices are not shown in FIG. 1 for ease of illustration, but their support is assumed. In one example, each network slice includes an SMF and a UPF, but the various network slices share the AMF 143, the PCF 147, and the UDM. In another example, each network slice includes an AMF, an SMF and a UPF. Although specific numbers and types of network functions are depicted in FIG. 1, one of skill in the art will recognize that any number and type of network functions may be included in the mobile core network 140.

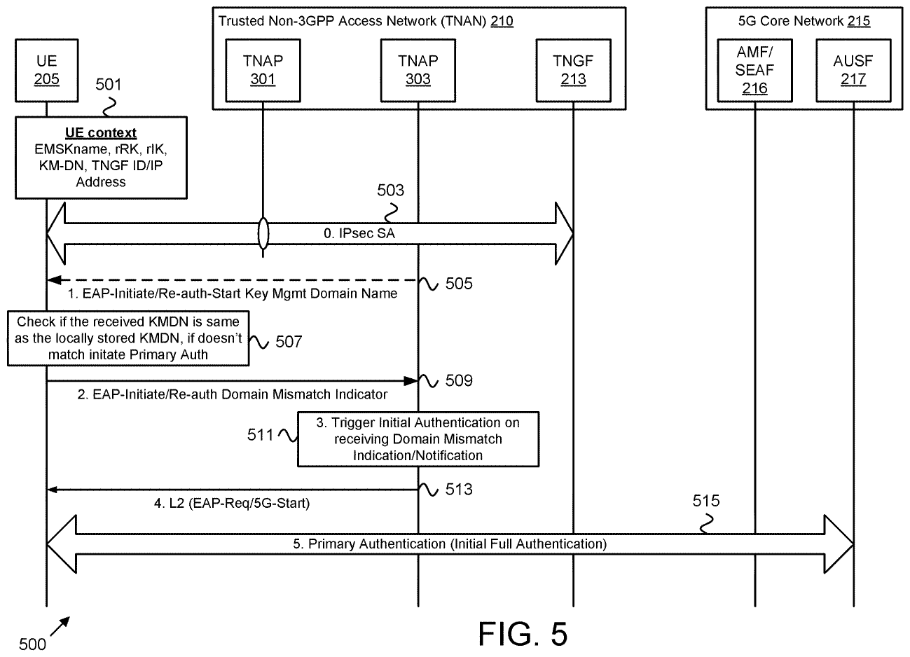

In various embodiments, the remote unit 105 sends an ERP support indicator when registering/authentication with the mobile core network 140 via the TNAN 120. Because the remote unit 105 supports ERP, the TNGF-1 125 performs ERP bootstrapping during the initial authentication as described below with reference to FIGS. 2A-2C. Thereafter, as the mobility of the remote unit 105 causes it to connect to a new base unit 121 in the TNAN 120, the remote unit reauthenticates using ERP as described below with reference to FIGS. 3A-3B and 4A-4C. Should the remote unit 105 leave a key-management domain (i.e., an area where the security keys can be shared with different TNGFs), then initial authentication will again be performed as described below with reference to FIG. 5.

FIGS. 2A-2C depict a procedure 200 for UE registration and authentication for a trusted non-3GPP access network, according to embodiments of the disclosure. The procedure 200 involves the UE 205 (e.g., one embodiment of the remote unit 105), a TNAN 210 (e.g., one embodiment of the TNAN 120) comprising a TNAP 211 and a TNGF 213 (e.g., one embodiment of the TNGF 123), and a 5G core network 215 (e.g., one embodiment of the mobile core network 140). In the most typical case, the TNAN 210 is a Wireless Local Area Network (“WLAN”) access network complying with the Institute of Electrical and Electronics Engineers (“IEEE”) 802.11 specification.

The procedure 200 begins at FIG. 2A, in Step 1 the UE 205 selects a PLMN and a TNAN 210 for connecting to this PLMN by using the TNAN selection procedure currently specified in Technical Specification (“TS”) 23.501, clause 6.3.12. During this procedure, the UE 205 discovers the PLMNs with which the TNAN 210 supports trusted connectivity (e.g. “5G connectivity”). A layer-2 (“L2”) connection (see connection 220) is established between the UE 205 and the TNAP 211. In the case of IEEE 802.11, this step corresponds to an 802.11 Association. In the case of Point-to-Point Protocol (PPP), this step corresponds to a PPP Link Control Protocol (LCP) negotiation. In other types of non-3GPP access (e.g., Ethernet), this step may not be required.

At Steps 2-3, an EAP authentication procedure is initiated. EAP messages (see messaging 222, 224) may be encapsulated into layer-2 packets, e.g., into IEEE 802.3/802.1x packets, into IEEE 802.11/802.1x packets, into PPP packets, or the like. The UE 205 provides an NAI that triggers the TNAP 211 to send an Authentication, Authorization, and Accounting (“AAA”) request to a TNGF 213. Note that an AAA interface exists between the TNAP 211 and TNGF 213. Between the TNAP 211 and TNGF 213, the EAP packets are encapsulated into AAA messages.

As Step 4, the UE 205 receives an L2 EAP-Req/5G-Start message from the TNGF 213 (see messaging 226). At Step 5, the UE 205 responds with an L2 message to the TNGF 213 (see messaging 228). The L2 message encapsulates an EAP-5G Response message (EAP-Res/5G-NAS) containing AN parameters (AN-Params) and a NAS registration request (NAS-PDU [Registration Request]). If the UE 205 supports ERP, the L2 message includes the ‘ERP Support Flag’ as part of the AN Parameters in the AN message or as an individual information element in the AN message that is sent along with the L2 message to the TNGF 213.

The UE 205 includes the ‘ERP Support Flag’ to indicate to the TNGF 213, acting as an ER Server, that the UE 205 supports ERP. In such an embodiment, the TNGF 213 can determine based on the received ‘ERP Support Flag’ and initiate implicit ERP bootstrapping along with the EAP authentication messages to fetch the reauthentication security context for subsequent reauthentication of the UE 205. The usage of the ‘ERP Support flag’ prevents unnecessary ERP implicit bootstrapping initiation at the TNGF 213 and saves network resources if the UE 205 does not support ERP.

In the absence of the ‘ERP Support Flag’ indication from the UE 205, if the TNGF 213 supports ERP and expects to support reauthentication using ERP, then without knowing whether the UE 205 is capable of ERP support, the TNGF 213 initiates an implicit ERP bootstrapping with the core network to receive the reauthentication security context from the EAP Server in the 5GC 215 (e.g., the AUSF 217). If the UE 205 does not support ERP, EAP-Initiate/Re-auth-Start messages that are sent to the UE 205 by the authenticator (TNAP 211) will be silently dropped by the UE 205 causing further waste of resources.

At step 6a, the TNGF 213 selects an AMF, i.e., the AMF portion of a combined AMF and Security Anchor Function (“SEAF”) 216 (denoted “AMF/SEAF”) in the 5GC 215, and determines to initiate ERP bootstrapping (see block 230). At step 6b, the TNGF 213 sends a N2 message to the AMF/SEAF 216 (see messaging 232). If an ‘ERP Support Flag’ is received from the UE 205 and if the TNGF 213 supports ERP, then the TNGF 213 includes the ‘ERP Key Request’ in the N2 message to initiate implicit bootstrapping and forwards the registration request received from the UE 205 to the AMF/SEAF 216. Alternatively, if an ‘ERP Support Flag’ is not received at the TNGF 213 from the UE 205 or if the TNGF 213 does not support ERP, in either case, the TNGF 213 does not include the ‘ERP Key Request’ in the N2 message and does not perform ERP implicit bootstrapping.

At step 7, the UE 205 and AMF/SEAF 216 exchange additional NAS messages over the EAP-5G session (see messaging 234). Examples of the additional NAS messages include, but are not limited to, those involved with NAS authentication of the UE 205.

At step 8a, the AMF/SEAF 216 sends the received ‘ERP Key Request’ along with the AAA key request in AAA interface/authentication request in a service-based interface (“SBI”) to the AUSF 217 in the 5GC 215 (see messaging 236). At optional step 8b, additional EAP message exchanges, if required, are performed between the UE 205 and the AUSF 217 (see messaging 238). The AUSF 217 further sends (see messaging 237) the authentication data request to the UDM 218 in the 5GC 215 and receives an authentication vector (“AV”) (i.e., an EAP Authentication and Key Agreement Prime (“EAP-AKA′ ”) AV), an authentication method indication, and a Subscription Permanent Identity (“SUPI”) from the UDM 218. The EAP-AKA′ AV is composed of a random challenge (“RAND”), an authentication token (“AUTN”), an expected result (“XRES”), a cipher key prime (“CK′ ”), and an integrity key prime (“IK′ ”).

In response to receiving an ‘ERP Key Request’ from the AMF/SEAF 216, then the AUSF 217 generates a reauthentication security context that includes deriving an rRK, an EMSKname, and an rRK Lifetime. As it relates to the subject matter disclosed herein, the rRK is used as the reauthentication root key and the EMSKname (a Keyname) is used as key identifier for the rRK. The rRK lifetime is assigned by the AUSF 217 and defines the validity or lifetime of the rRK key. On expiry of the rRK lifetime, the TNGF 213 of the TNAN 210, acting as the ER Server, attempts to perform a full authentication.

The rRK is derived using a Key Derivation Function (“KDF”) (see block 250). In a first option, the EMSK, SUPI, and Serving Network Name/Home network ID (“SNN/HNID”) are used as parameters for the KDF. For instance, the rRK may be derived using a KDF (i.e., a cryptographic hash function) and the following formula:

$$rRK = KDF ( EMSK , SUPI , SNN / HNID \vert rRK Label \vert ‘ \backslash 0 ’ \vert length ) \qquad Equation 1$$

As used herein, the parameter “rRK Label” refers to a string (e.g., 8-bit American Standard Code for Information Interchange (“ASCII”) string). The rRK Label may be preassigned by an authority, such as a standards organization. The length field refers to the length (e.g., in octets) of the derived key (i.e., the rRK in Equation 1). In various embodiments, the length field may be encoded as specified in IETF RFC 5295. Note that the parameters <EMSK>, <SUPI>, and <SNN/HNID|rRK Label|‘\0’|length> are three inputs to the KDF, where the ‘|’ operator indicates concatenation. Here, the value ‘\0’ may be used to show separation between various inputs and length.

In a second option, the AUSF key (K_{AUSF}), SUPI, SNN/HNID are used as parameters for the KDF. For instance, the rRK may be derived using a KDF and the following formula:

$$rRK = KDF ( {K}_{AUSF} , SUPI , SNN / HNID \vert rRK Label \vert ‘ \backslash 0 ’ \vert length ) \qquad Equation 2$$

Note that the parameters <K_{AUSF>}, <SUPI>, and <SNN/HNID|rRK Label|‘\0’|length> are three inputs to the KDF, where the ‘|’ operator indicates concatenation. Here, the value ‘\0’ may be used to show separation between various inputs and length. The length field refers to the length (e.g., in octets) of the derived key (i.e., the rRK derived in Equation 2).

In either implementation, the home network ID (“HNID”) may include the mobile country code (“MCC”) and mobile network code (“MNC”) of the international mobile subscriber identity (“IMSI”) and/or NAI. The Serving Network Name (“SNN”) is the name of the serving network which contains the Serving Network Identifier (“SNID”) and the 5G code. Further, if the rRK is generated from the EMSK, then the derivation of the corresponding key identifier, EMSKname (see block 250), is performed using a KDF with EAP Session-ID, SUPI, SNN/HNID, and EMSK being used as parameters, e.g., derived using the following formula:

$$EMSKname = KDF ( EAP Session - ID , SUPI , SNN / HNID , “ EMSK ” \vert ‘ \backslash 0 ’ \vert length ) \qquad Equation 3$$

Note that the parameters <EAP Session-ID>, <SUPI>, <SNN/HNID>, and <EMSK |rRK Label|‘\0’|length> are four inputs to the KDF, where the ‘|’ operator indicates concatenation. Here, the value ‘\0’ may be used to show separation between various inputs and length. The length field refers to the length (e.g., in octets) of the derived parameter (i.e., the EMSKname in Equation 3).

If rRK is derived from K_{AUSF}, then a corresponding key identifier, Kausfname, can be derived using a KDF with EAP Session-ID, SUPI, SNN/HNID, and K_{AUSF} being used as parameters, e.g., derived using the following formula:

$$Kausfname = KDF ( EAP Session - ID , SUPI , SNN / HNID , “ {K}_{AUSF} ” \vert ‘ \backslash 0 ’ \vert length ) \qquad Equation 4$$

Subsequent reauthentication procedures can use the Keyname Kausfname instead of the Keyname EMSKname, accordingly. Note that the parameters <EAP Session-ID>, <SUPI>, <SNN/HNID>, and <K_{AUSF}|rRK Label|‘\0’|length> are four inputs to the KDF, where the ‘|’ operator indicates concatenation. Here, the value ‘\0’ may be used to show separation between various inputs and length. The length field refers to the length (e.g., in octets) of the derived parameter (i.e., the Kausfname in Equation 4).

The AUSF 217 in the 5GC 215 provides (see messaging 240) the freshly generated reauthentication security context (comprised of rRK, EMSKname or Kausfname, and rRK Lifetime) along with a SEAF Key and an EAP Success flag in the AAA Key Response message to the SEAF in the 5GC 215, shown here collocated with the AMF in the 5GC 215. The SEAF in the 5GC 215 (e.g., the SEAF portion of the AMF/SEAF 216) forwards the reauthentication security context to the AMF in the 5GC 215 (e.g., the AMF portion of the AMF/SEAF 216) along with an AMF key (e.g., derived from the SEAF key) and a Key management domain name based on local policy for the reauthentication security context. The AMF in the 5GC 215 locally stores the reauthentication security context until a successful NAS Security Mode Control (“NAS SMC”) procedure is performed with the UE 205.

At steps 9a-9d, the UE 205 and AMF/SEAF 216 in the 5GC 215 exchange additional NAS messages over the EAP-5G session (see messaging 242-248, FIG. 2B). Examples of the additional NAS messages include, but are not limited to, those involved with NAS authentication or reauthentication.

At step 10, a TNGF security key (K_{TNGF}) is created in the UE 205 and in the AMF/SEAF 216 in the 5GC 215 after the successful authentication. The K_{TNGF} is transferred from the AMF/SEAF 216 to TNGF 213 in the TNAN 210 in step 10a (within the N2 Initial Context Setup Request see messaging 252).

Additionally, after a successful UE authentication and NAS SMC, the AMF/SEAF 216 in the 5GC 215 sends (see messaging 252) the reauthentication security context (e.g., rRK, EMSKname, rRK Lifetime) along with the corresponding KM-DN and K_{TNGF} in the N2 Initial Context Setup Request message. Note that the TNGF 213 may be already pre-configured with the KM-DN, in which case the N2 Initial Context Setup Request message may exclude the KM-DN.

At step 10b, the TNGF 213 in the TNAN 210 locally stores (see block 254) the received reauthentication security context (e.g., rRK, EMSKname, rRK Lifetime) and KM-DN (if provided by the AMF/SEAF as no pre-configuration possible at the TNGF). Alternatively, based on the TNGF's association with the TNAP 211 in the TNAN 210, the TNGF 213 may be pre-provisioned/pre-configured with a KM-DN either by the operator or by other means which are outside the scope of this disclosure.

The KM-DN, as used herein, indicates a group of TNGFs 213 and TNAPs 211 in the TNAN 210 that can share the same reauthentication security context to perform ERP based reauthentication of a UE 205 that is accessing a service in the 5GC 215, e.g., via the specified group of TNGFs 213 in the TNAN 210. The KM-DN remains the same for all TNGFs 213 in the TNAN 210 that share the same reauthentication security context. The bootstrapping procedure illustrated in FIGS. 2A-2C plays a main role in controlling the sharing of the UE's reauthentication security context among TNGFs 213 in the TNAN 210 belonging to the same key management domain to ensure the security level of the UE 205 reauthentication security context.

After receiving the TNGF key from AMF/SEAF 216 in the 5GC 215 in step 10a, the TNGF 213 in the TNAN 210 sends (see messaging 260, FIG. 2C) an EAP-Request/5G-Notification packet containing the “TNGF Contact Info” to the UE 205, which includes the Internet Protocol (“IP”) address of TNGF 213, the TNGF-ID, and the KM-DN.

The TNGF 213 derives (see block 256) a dynamic rIK, for securely exchanging and verifying ERP messages, using a KDF with the rRK, KM-DN, Sequence Number (“SEQ”) (initialized to ‘0’ or ‘1’ during EAP full authentication and incremented for every ERP run related usage) and an rIK label as parameters—e.g., derived using the following formula:

$$rIK = KDF ( rRK , KM - DN , SEQ , rIK Label \vert ‘ \backslash 0 ’ \vert cryptosuite \vert length ) \qquad Equation 5$$

Note that the parameters <rRK>, <KM-DN>, <SEQ>, and <rIK Label|‘\0’|cryptosuite|length> are four inputs to the KDF, where the ‘|’ operator indicates concatenation. As used herein, the parameter “rIK Label” refers to a string (e.g., 8-bit ASCII string). Here, the value ‘\0’ may be used to show separation between various inputs and length. The length field refers to the length (e.g., in octets) of the derived key (i.e., the rIK derived in Equation 5).

The TNGF 213 in the TNAN 210 locally stores to UE context the received reauthentication security context (e.g., rRK, EMSKname, Lifetime and Key management domain) along with the rIK if derived (see block 258).

The UE 205, either now or after receiving EAP Success in Step 10f, derives the reauthentication security context, e.g., EMSKname, rRK, and dynamic rIK (see blocks 262, 264), for securely exchanging and verifying ERP messages, using a KDF with the rRK, KM-DN, and an rIK label as parameters—e.g., derived using the Equation 5, similar to the TNGF 213 of the TNAN 210.

The UE 205 locally stores the received TNGF ID, TNGF IP Address and KM-DN to support subsequent reauthentication (see block 266). The TNAP 211 in the TNAN 210 is a trusted entity. The TNGF 213 in the TNAN 210 generates the K_{TNAP} as currently specified in Annex A.22 and transfers it from the TNGF 213 to the TNAP 211 in step 10c (e.g., within a AAA message), along with the KM-DN.

The UE 205 sends (see messaging 268) the EAP-Res/5G-Notification message to the TNGF 213 in the TNAN 210. After receiving the EAP-Response/5G-Notification packet from the UE 205, the TNGF 213 in the TNAN 210 sends (see messaging 270) the message containing the EAP-Success packet along with the TNAP key to the TNAP 211 in the TNAN 210. The TNAP 211 forwards (see messaging 272) the packet containing the EAP-Success in an L2 message to the UE 205.

In Step 11, the UE 205 and the TNAP 211 in the TNAN 210 uses the common TNAP key to derive security keys according to the applied non-3GPP technology and to establish a security association to protect subsequent traffic (see messaging 274). In case of IEEE 802.11, for example, the K_{TNAP} is the Pairwise Master Key (“PMK”), and a 4-way handshake is executed (see IEEE 802.11) to establish a security context between the TNAP 211 (e.g., WLAN access point) in the TNAN 210 and the UE 205 that is used to protect unicast and multicast traffic over the air. Messages between the UE 205 and the TNAP 211 in the TNAN 210 are encrypted and integrity protected from this step onwards.

FIGS. 3A-3B depict a procedure for a 5G reauthentication over a trusted non-3GPP access network, according to embodiments of the disclosure. The procedure 300 involves the UE 205 (e.g., one embodiment of the remote unit 105), a first/current/source TNAP 301, a second/new/target TNAP 303, and a TNGF 213 in the TNAN 210.

Intra-TNGF Mobility, as used herein, is defined as the mobility of a UE 205 between two TNAPs 301, 303 connected to a single/same TNGF 213 in a TNAN 210. As the UE 205 might have been previously authenticated with the TNAN 210 via the same TNGF 213 and the TNGF 213 possesses the reauthentication security context, as derived during ERP implicit bootstrapping as described above with reference to the procedure 200 illustrated in FIGS. 2A-2C, an ERP based reauthentication will be sufficient for the network to provide access to the UE 205 without performing a full authentication again, thereby avoiding multiple different interactions with the 5GC core network 215 and reducing handover latency. In this manner, the procedure 300 described below and illustrated in FIGS. 3A-3B provides for reauthentication that reduces conventional reauthentication complexity in a TNAN 210.

As shown in FIG. 3A, in step 0, an IPsec Security Association (“SA”) connection (see connection 309) is established between the UE 205, the current/source TNAP 301, the new/target TNAP 303, and the TNGF 213 in the TNAN 210. In step 1, ERP exchange is triggered by the new/target TNAP 303 (e.g., ER Authenticator) by sending an EAP-5G Start message (see EAP-Initiate/Re-auth-Start message 311) with the KM-DN to the UE 205.

The UE 205 and the TNGF 213 may both have locally stored instances of the UE context (i.e., reauthentication security context), including the EMSKname, rRK, rIK, KM-DN, and TNGF ID/IP address (see block 305 for the UE 205 and block 306 for the TNGF 213). Accordingly, in step 2, the UE 205 verifies the locally stored KM-DN and the one received from the new/target TNAP 303 are the same. If so, then the UE 205 forms the Keyname-NAI as EMSKname@Domain-name (see block 313) and sends (see messaging 315) an EAP-Initiate/Re-auth message to the new/target TNAP 303 (e.g., ER Authenticator). As used herein, a “Keyname-NAI” refers to an NAI (i.e., having the form “username@realm”) where the username portion is a key identifier (i.e., Keyname) pointing to a security key (e.g., the EMSKname which points to the EMSK). Note that in alternative embodiments, the Keyname-NAI may have the form Kausfname@Domain-name, instead of EMSKname@Domain-name, as discussed above.

The parameter Domain-name used in the realm of Keyname-NAI (i.e., Keyname-NAI=Keyname@Domain-name) is generated by the UE 205 using the values for TNGF Info and KM-DN as follows: TNGF-ID. KM-DN (see block 317). If the UE 205 contains a previously derived rIK (derived as explained above and shown in block 307) related to the KM-DN, it uses the rIK to integrity protect the ERP exchanges between the UE 205 and the TNGF 213 (e.g., ER Server).

If the UE 205 does not have a locally stored instance of a previously derived rIK, then a static or a fresh rIK (if the UE determines to derive fresh rIK) can be derived by the UE 205. A static rIK, e.g., an rIK that does not change for every ERP run, may be derived using a KDF with the following formula:

$$rIK = KDF ( rRK , KM - DN , rIK Label \vert ‘ \backslash 0 ’ \vert cryptosuite \vert length ) \qquad Equation 6$$

Note that the parameters <rRK>, <KM-DN>, and <rIK Label|‘\0’|cryptosuite|length> are three inputs to the KDF, where the ‘|’ operator indicates concatenation. Here, the value ‘\0’ may be used to show separation between various inputs and length. The length field refers to the length (e.g., in octets) of the derived key (i.e., the rIK derived in Equation 6).

Note that if a static rIK is used, rIK leakage will breach all the subsequent reauthentication security between the same UE and the same or different TNGFs. Therefore, a fresh rIK, e.g., an rIK that is generated for every ERP run, may be derived using a KDF according to Equation 5, above.

Note the use of a SEQ as a parameter for generating a fresh rIK for every ERP run or when required. The SEQ is incremented after every usage as input to key derivation to ensure freshness of the key. The EAP-Initiate/Re-auth message (see messaging 315) sent by UE 205 contains EMSKname@Domain-name, and in addition the SEQ associated with the rIK, Cryptosuite, and authentication Tag (e.g., a first Message Authentication Code (“MAC1”)).

In step 3, the new/target TNAP 303 (e.g., ER Authenticator) processes the message and sends (see messaging 321) an AAA message to the TNGF 213 (e.g., ER server) based on the realm part of the NAI (i.e., domain name) by forwarding (see block 319) the received EAP-Initiate/Re-auth message. The TNGF information (e.g., TNGF IP address or TNGF ID) in the realm part (e.g., domain name) of the NAI helps the new/target TNAP 303 to forward the message to the right TNGF 213 if it is reachable (see messaging 321).

In step 4a-4b, the TNGF 213 (e.g., ER server) verifies (see block 323) the domain name and validity of the ERP message by checking the EMSKname in the username part of the NAI and using the SEQ associated with the rIK for integrity checking the ERP message (see block 325, FIG. 3B). If verification is successful, then the UE 205 is successfully authenticated (see block 326). If the TNGF 213 does not have an rIK in its local memory, then the TNGF 213 fetches the reauthentication security context associated with the EMSKname and derives the rIK (as explained above and illustrated in block 328) to verify the received ERP message's integrity.

In step 4c, if the reauthentication is successful, the TNGF 213 (e.g., ER Server) generates a fresh rMSK (see blocks 327 and 328). In step 5a, the TNGF 213 provides the rMSK to the new/target TNAP 303 (e.g., ER Authenticator) in the AAA response message (see messaging 329) along with the EAP-Finish/Re-auth message containing EMSKname@Domain-name, SEQ, Cryptosuite and a second Message Authentication Code (“MAC2”). The MAC2 is the authentication tag for integrity protecting the ERP message sent from the TNGF 213 to the UE 205. The rMSK is generated using a KDF with the rRK, Trusted Access code, rMSK Label, and SEQ as parameters-e.g., derived using the following formula:

$$rMSK = KDF ( rRK , Trusted Access code , rMSK Label \vert ‘ \backslash 0 ’ \vert SEQ \vert length ) \qquad Equation 7$$

Note that the parameters <rRK>, <Trusted Access code>, and <rMSK Label|‘\0’|SEQ |length> are three inputs to the KDF, where the ‘|’ operator indicates concatenation. As used herein, the parameter “rMSK Label” refers to a string (e.g., 8-bit ASCII string). Here, the value ‘\0’ may be used to show separation between various inputs and length. The length field refers to the length (e.g., in octets) of the derived key (i.e., the rMSK derived in Equation 7).

The new/target TNAP 303 (e.g., ER Authenticator) retrieves the rMSK and forwards (see step 5b, messaging 331) the EAP-Finish/Re-auth message to the UE 205.

In steps 6a-6b, the UE 205 verifies (see block 333) the MAC2 using the SEQ associated with the rIK and derives (see blocks 335 and 336) the rMSK similar to the TNGF 213 as described in step 4c. Alternatively, the UE 205 and the TNGF 213, based on the described implementation, can derive, and use, fresh rIKs for MAC1 and MAC2 computations respectively by using a most recent SEQ number as the input as described above with respect to steps 4a-b above. When an rIK is derived and used, the associated SEQ can be incremented at the UE 205 and the TNGF 213 accordingly.

In step 7, the UE 205 and the new/target TNAP 303 (e.g., ER Authenticator) use the freshly derived rMSK (e.g., TNAP key) to derive security keys according to the applied non-3GPP technology and to establish security over the air (see messaging 337). In step 8, the UE 205 and the new/target TNAP 303 establish a security association, e.g., an IPsec SA, to protect subsequent traffic between the UE 205, the new/target TNAP 303, and the TNGF 213 (see connection 339).

FIGS. 4A-4C depict a procedure for a 5G reauthentication over a trusted non-3GPP access network, according to embodiments of the disclosure. The procedure 400 involves the UE 205 (e.g., one embodiment of the remote unit 105), a first/current/source TNAP 301, a second/new/target TNAP 303, a source TNGF 401, and a target TNGF 403 in the TNAN 210.

An Inter-TNGF Mobility is defined as the mobility of a UE 205 between two TNAPs 301, 303 connected to two different TNGFs 401, 403. If two TNGFs 401 and 403 belong to the same operator's network, e.g., TNAN 210, and if the source TNGF 401 and target TNGF 403 are connected with a Tn interface, then the UE 205 can be reauthenticated using ERP based on the reauthentication security context (see blocks 402, 404) made available to the Source TNGF 401.

As shown in FIGS. 4A-4C, in step 0, an IPsec SA connection (see connection 405) is established between the UE 205, the current/source TNAP 301, the new/target TNAP 303, and the source TNGF 401 in the TNAN 210. In step 1, ERP exchange is triggered by the new/target TNAP 303 (e.g., ER Authenticator) by sending an EAP-Initiate/Re-auth-Start message (see messaging 407) with the KM-DN to the UE 205.

The UE 205 and the source TNGF 401 may both have locally stored instances of the UE context (i.e., reauthentication security context), including the EMSKname, rRK, rIK, KM-DN, and TNGF ID/IP address (see block 402 for the UE 205 and block 404 for the TNGF 213). Accordingly, in step 2a, the UE 205 verifies (see block 409) the locally stored KM-DN and the one received from the new/target TNAP 303 are the same. If so, then in step 2b the UE 205 forms the Keyname-NAI as EMSKname@Domain-name and sends (see messaging 411) an EAP-Initiate/Re-auth message to the new/target TNAP 303 (e.g., ER Authenticator).

The domain name here includes only information for the previously authenticated/reauthenticated TNGF 401 (e.g., TNGF ID or TNGF IP address), because only that TNGF 401 contains the reauthentication security context of the UE 205. The domain name used in the realm of NAI is generated by the UE 205 using the values for TNGF Info and KM-DN as follows: TNGF-ID. KM-DN. If the UE 205 contains a previously derived rIK (derived as explained above and shown in block 307) related to the KM-DN, it uses the rIK to integrity-protect the ERP exchanges between the UE 205 and the TNGF 401 (e.g., ER Server).

If the UE 205 does not have a locally stored instance of a previously derived rIK, then a static or a fresh rIK (if the UE determines to derive fresh rIK) can be derived by the UE 205. A static rIK, e.g., an rIK that does not change for every ERP run, is derived using as KDF according to Equation 6, above. A fresh rIK, e.g., an rIK that is generated for every ERP run or when required, is derived using a KDF according to Equation 5, above. Note the use of a SEQ as a parameter for generating a fresh rIK for every ERP run or when required. The SEQ is incremented after every usage as input to key derivation to ensure freshness of the key (such as rIK and session key). The EAP-Initiate/Re-auth message (see messaging 411) sent by UE 205 contains EMSKname@Domain-name, and in addition the SEQ associated with the rIK, Cryptosuite, and authentication Tag (e.g., MAC1).

In step 3a, the new TNAP 303 (e.g., ER Authenticator) processes the message (e.g., as in IETF RFC 6696) and determines that the source TNGF 401 specified in the domain name is not reachable to the new TNAP 303 (see block 413). In step 3b, the new TNAP 303 sends (see messaging 415) an AAA message to the new target TNGF 403 (e.g., ER server) based on the KM-DN by forwarding the received EAP-Initiate/Re-auth message.

Alternatively, the TNGF information (e.g., the TNGF IP address or ID) in the realm part (e.g., the domain name) of the NAI helps the new/target TNAP 303 to forward the message to the correct TNGF 403, if it is reachable, and in that case the procedure is similar to the intra-TNGF mobility as described above.

The target TNGF 403 (e.g., ER server 2) verifies the KM-domain name and determines, e.g., based on the EMSKname in the NAI username, that the TNGF 403 does not have any reauthentication security context for the UE 205 at its side. The target TNGF 403, however, determines from the NAI realm part that the domain name contains a TNGF IP address and/or TNGF ID of the source TNGF 401 with which the target TNGF 403 has a Tn interface. In step 3c, the target TNGF 403 forwards the EAP-Initiate/Re-auth message in Re-auth Data Request over the Tn interface to the source TNGF 401 (see messaging 417).

In steps 4a-4b, FIG. 4B, the source TNGF 401 verifies (see block 419) the domain name in the received NAI realm part and checks the validity (see block 421) of the ERP message by checking the EMSKname in the username part of the NAI and using the SEQ associated with rIK for integrity check of the ERP message. The source TNGF 401 uses the static rIK locally stored (derived as explained above) and associated with the SEQ and EMSKname, if the static rIK is used based on UE 205 and TNGF 401 implementations.

Alternatively, a fresh rIK (derived as explained above) is used by the UE 205 and the source TNGF 401 based on the operator's implementation, e.g., the TNAN 210 configuration/implementation. The source TNGF derives and uses the rIK associated with the SEQ received by fetching the reauthentication security context associated with the EMSKname to verify the received ERP message's integrity.

In step 5, if the verification of MAC1 is successful and if the received KM-DN matches the KM-DN locally stored, then the source TNGF 401 provides the reauthentication security context (e.g., rRK, rIK, SEQ, rRK Lifetime) to the target TNGF 403 in the Tn Re-auth Data Response message (see messaging 423).

In steps 6a-6b, if the reauthentication security is successfully received, the target TNGF 403 locally stores the reauthentication security context (e.g., rRK, rIK (can be a fresh or static rIK), EMSKname, Lifetime, SEQ, updated domain name). Further, the target TNGF 403 (e.g., ER Authenticator) generates or derives (see blocks 425 and 426) a fresh rMSK, e.g., by incrementing the SEQ value and using Equation 7, as specified above, and updates (see block 427) the realm part of the KeyName-NAI, e.g., domain name with its TNGF IP address and/or ID.

In step 7a, the target TNGF 403 provides the new rMSK to the new/target TNAP 303 (e.g., ER Authenticator) in the AAA Response message (see messaging 429) along with the EAP-Finish/Re-auth message containing updated EMSKname@Domain-name (where the updated EMSKname@Domain-name contains the target TNGF 403 info in the domain name part as it holds currently the reauthentication security context), SEQ, Cryptosuite and MAC2. MAC2 is the authentication tag for integrity protecting the ERP message sent from target TNGF 403 to the UE 205.

In step 7b, the new/target TNAP 303 (e.g., ER Authenticator) retrieves the rMSK and forwards (see messaging 431) the EAP-Finish/Re-auth containing updated KeyName-NAI: EMSKname@Domain-name, SEQ, Cryptosuite, and MAC2 to the UE 205. As shown in block 433, as rRK is now available in TNGF 2, the EMSKname@Domain-name should point to the target TNGF 403.

Continuing at FIG. 4C, in steps 8a-8b, the UE 205 verifies (see block 435) the MAC2 using the SEQ associated with rIK and derives rMSK (see blocks 437 and 438) similar to the target TNGF 403, e.g., using Equation 7, as specified above. The UE 205 further verifies the domain name in the received KeyName-NAI and if it is different from the locally stored domain name, the UE 205 saves the recently received domain name along with the reauthentication security context and deletes the old (previously stored) domain name form its memory.

Alternatively, the UE 205 and the target TNGF 403, based on the implementation, can derive, and use, fresh rIKs for MAC1 and MAC2 computations respectively by using an SEQ number as the input as explained above. Whenever a rIK is derived and used, the associated SEQ is incremented at the UE 205 and the target TNGF 403 accordingly.

In step 9, the UE 205 and the new/target TNAP 303 (e.g., ER Authenticator) uses the freshly derived rMSK (e.g., TNAP key) to derive security keys according to the applied non-3GPP technology and to establish security over the air (see messaging 439). In step 10, the UE 205 and the new/target TNAP 303 (e.g., ER Authenticator) establish a security association, e.g., an IPsec SA, to protect subsequent traffic between the UE 205, the new/target TNAP 303, and the TNGF 403 (see connection 441).

FIG. 5 depicts a procedure 500 for an EAP-5G session over a trusted non-3GPP access network, according to embodiments of the disclosure. The procedure 500 involves the UE 205 (e.g., one embodiment of the remote unit 105), a TNAN 210 (e.g., one embodiment of the TNAN 120) comprising a current TNAP 301, a target TNAP 303, and a TNGF 213 (e.g., one embodiment of the TNGF 123), and a 5G core network 215 (e.g., one embodiment of the mobile core network 140). In the most typical case, the TNAN 210 is a WLAN access network complying with the IEEE 802.11 specification.

The key management domain as defined above plays a main role in controlling the sharing of the UE's reauthentication security context among only TNGFs 213 that belong to the same key management domain. If a UE 205 moves to a different TNAP 303 that is connected to a new TNGF 213 that belongs to a different key management domain, then the new TNGF 213 will not be provided with reauthentication security context by the old TNGF 213 whose key management domain is different.

Hence, the UE 205 cannot perform reauthentication with a new TNGF 213 belonging to a different key management domain, using its locally stored reauthentication security context. Consequently, an initial primary authentication is triggered with the new TNAP 303 and new TNGF 213 belonging to a different key management domain. FIG. 5 describes how a key management domain control can be imposed by the TNAN 210 and the UE 205 to ensure safety and reliability of the reauthentication security context among a group of network functions/entities forming a key management domain.

As shown in FIG. 5, in step 0, an IPsec SA connection (see connection 503) is established between the UE 205, the current/source TNAP 301, the new/target TNAP 303, and the TNGF 213 in the TNAN 210. In step 1, ERP exchange is triggered by the new/target TNAP 303 (e.g., ER Authenticator) by sending an EAP-Initiate/Re-auth-Start message (see messaging 505) with the KM-DN to the UE 205.

The UE 205 may have locally stored instances of the UE context (i.e., UE reauthentication security context) (see block 501), including the EMSKname, rRK, rIK, KM-DN, and TNGF ID/IP address. Accordingly, the UE 205 verifies (see block 507) the locally stored KM-DN and the one received from the new/target TNAP 303 are the same. If not, then the UE 205 sends a ‘Domain Mismatch Indicator’ (can alternatively be called a KM-DN Mismatch Indicator/Flag) to the target TNAP 303 in the EAP-Initiate/Re-auth message (see messaging 509).

In step 3, the new/target TNAP 303 triggers (see block 511) an initial EAP full authentication (e.g., primary authentication) for the UE 205 with the 5G core network 215 via the associated TNGF 213 in response to the received ‘Domain Mismatch Indicator’.

In step 4, the new/target TNAP 303 sends the EAP-Req/5G-Start message (see messaging 513) over L2 to the UE 205 to initiate the primary authentication. In step 5, primary authentication (see 515) follows the procedure 200 described above in reference to FIGS. 2A-2C.

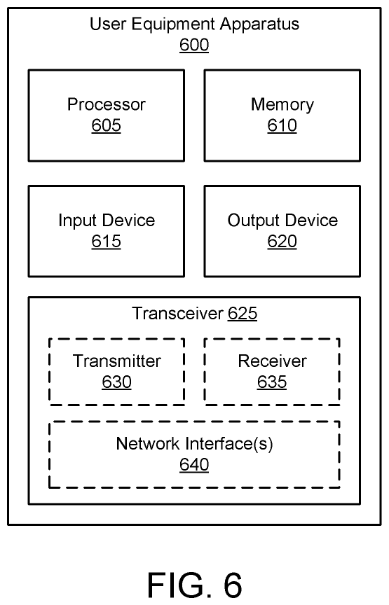

FIG. 6 depicts one embodiment of a user equipment apparatus 600, according to embodiments of the disclosure. The user equipment apparatus 600 may be one embodiment of the remote unit 105 and/or the UE 205. Furthermore, the user equipment apparatus 600 may include a processor 605, a memory 610, an input device 615, an output device 620, a transceiver 625. In some embodiments, the input device 615 and the output device 620 are combined into a single device, such as a touch screen. In certain embodiments, the user equipment apparatus 600 does not include any input device 615 and/or output device 620.

As depicted, the transceiver 625 includes at least one transmitter 630 and at least one receiver 635. Here, the transceiver 625 communicates with a mobile core network (e.g., a 5GC) via an access network. Additionally, the transceiver 625 may support at least one network interface 640. Here, the at least one network interface 640 facilitates communication with an TNGF (e.g., using the “NWt” interface). Additionally, the at least one network interface 640 may include an interface used for communications with an AMF, an SMF, and/or a UPF.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In some embodiments, the processor 605 sends (via the transceiver 625) a first authentication message to a network function to authenticate with the mobile communication network. Here, the first authentication message contains an indicator that the apparatus supports ERP. The processor 605 receives (via the transceiver 625) a second authentication message from the network function in response to the first authentication message, where the second authentication message contains a KM-DN, the KM-DN indicating a group of network functions that can share reauthentication security context for the apparatus to perform ERP. In response to successful authentication with the mobile communication network, the processor 605 derives reauthentication security context and locally stores (i.e., in the memory 610) the received KM-DN and the derived reauthentication security context for subsequent reauthentication with the mobile communication network.

In some embodiments, the network function comprises a gateway function of the mobile communication network (i.e., a TNGF in a TNAN), the gateway function fetching reauthentication security context for subsequent reauthentication of the apparatus in response to the first authentication message including the ERP indicator.

In some embodiments, the derived reauthentication security context includes an rRK and a key identifier for the rRK (i.e., EMSKname and/or Kausfname). In such embodiments, the rRK is derived using a key derivation function based on an EMSK, a SUPI, and a serving network name (e.g., 5G:Serving Network ID). Alternatively, the rRK is derived using a key derivation function based on an authentication server function key (i.e., AUSF key, K_{AUSF}), the SUPI, and the serving network name.

In certain embodiments, in response to deriving the rRK based on the EMSK, the processor 605 derives a key identifier for the rRK (i.e., “EMSKname”) using a key derivation function based on at least the SUPI and the serving network name. In other embodiments, in response to deriving the rRK based on the AUSF key (i.e., K_{AUSF}), the processor 605 derives a key identifier for the rRK (i.e., “Kausfname”) using a key derivation function based on the SUPI, the serving network name, and the AUSF key (i.e., K_{AUSF}), where Kausfname is used for subsequent reauthentication procedures.

In some embodiments, the processor 605 further receives a third authentication message from a new access point of the mobile communication network (e.g., TNAP-2) in response to the user equipment apparatus 600 connecting to the new access point in the TNAN. Here, the third authentication message includes a second KM-DN.

In certain embodiments, the processor 605 derives a reauthentication integrity key (i.e., “rIK”) for securely exchanging and verifying ERP messages with the network function, where the processor 605 derives the rIK at least in part from the KM-DN and a sequence number (i.e., “SEQ”). In such embodiments, the processor 605 may further increment a received SEQ prior to using the SEQ to derive the rIK.

In certain embodiments, the processor 605 verifies whether the second KM-DN matches the locally stored KM-DN associated with the reauthentication security context. In such embodiments, the processor 605, in response to verifying that the second KM-DN matches the locally stored KM-DN, further generates an NAI and sends a fourth authentication message comprising the NAI to the new access point, the generated NAI stored locally at the apparatus for subsequent reference.

In certain embodiments, the NAI is generated based on a key identifier for an rRK (i.e., “EMSKname”) and a domain name, the domain name generated using an identifier for a previously authenticated network gateway function in the TNAN and the KM-DN such that the NAI has a form of “EMSKname@Domain-name.”

In some embodiments, the processor 605 further receives a fifth authentication message comprising an updated NAI from the new access point and verifies that the domain name for the updated NAI matches the locally stored domain name. In certain embodiments, the processor 605, in response to verifying that the domain name for the updated NAI matches the locally stored domain name, deletes the current locally stored domain name and locally stores the updated domain name and reauthentication security context.

In some embodiments, the processor 605, in response to verifying that the received KM-DN fails to match the locally stored KM-DN, sends a domain mismatch indicator to the new access point in an EAP-Initiate/RE-auth message to trigger initial EAP full authentication for the apparatus.

The memory 610, in one embodiment, is a computer-readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data relating to supporting remote unit (e.g., UE) reauthentication, for example storing security keys, IP addresses, and the like. In certain embodiments, the memory 610 also stores program code and related data, such as an operating system (“OS”) or other controller algorithms operating on the user equipment apparatus 600 and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, may include any known electronically controllable display or display device. The output device 620 may be designed to output visual, audible, and/or haptic signals. In some embodiments, the output device 620 includes an electronic display capable of outputting visual data to a user. For example, the output device 620 may include, but is not limited to, a liquid crystal display (“LCD”), a light-emitting diode (“LED”) display, an organic LED (“OLED”) display, a projector, or similar display device capable of outputting images, text, or the like to a user. As another, non-limiting, example, the output device 620 may include a wearable display such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, all or portions of the output device 620 may be located near the input device 615.

As discussed above, the transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver (or portions thereof) at particular times in order to send and receive messages.

The transceiver 625 may include one or more transmitters 630 and one or more receivers 635. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an application-specific integrated circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

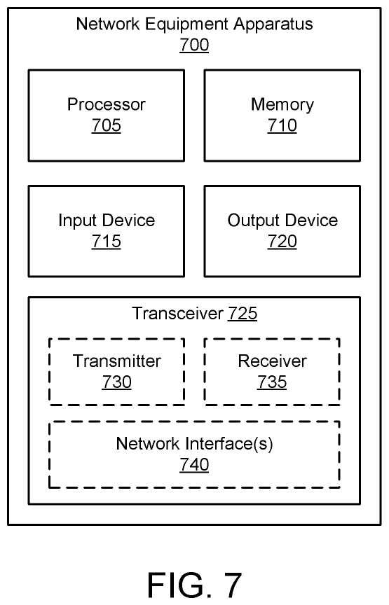

FIG. 7 depicts one embodiment of a network equipment apparatus 700, according to embodiments of the disclosure. In some embodiments, the network equipment apparatus 700 may be one embodiment of a TNGF (i.e., TNGF1 and/or TNGF2). In other embodiments, the network equipment apparatus 700 may be one embodiment of an AMF. Furthermore, network equipment apparatus 700 may include a processor 705, a memory 710, an input device 715, an output device 720, a transceiver 725. In some embodiments, the input device 715 and the output device 720 are combined into a single device, such as a touch screen. In certain embodiments, the network equipment apparatus 700 does not include any input device 715 and/or output device 720.

As depicted, the transceiver 725 includes at least one transmitter 730 and at least one receiver 735. Here, the transceiver 725 communicates with one or more remote units 105. Additionally, the transceiver 725 may support at least one network interface 740, such as the NWt, N2, and N3 interfaces depicted in FIG. 1. In some embodiments, the transceiver 725 supports a first interface for communicating with a RAN node, a second interface for communicating with one or more network functions in a mobile core network (e.g., a 5GC) and a third interface for communicating with a remote unit (e.g., UE).

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, an FPGA, or similar programmable controller. In some embodiments, the processor 705 executes instructions stored in the memory 710 to perform the methods and routines described herein. The processor 705 is communicatively coupled to the memory 710, the input device 715, the output device 720, and the first transceiver 725.

In various embodiments, the processor 705 controls the network equipment apparatus 700 to implement the above described TNGF behaviors. In some embodiments, the processor 705 receives a first authentication message for reauthenticating a remote unit (i.e., UE), where the first authentication message includes a Keyname-NAI comprising a first username (e.g., Keyname or other key identifier) and a first domain name. Here, the first domain name identifies a KM-DN and an associated gateway function holding the reauthentication security context. The processor 705 verifies the first domain name and validates the first authentication message using at least the rIK from the security context identified by the first username. The processor 705 generates a second authentication message in response to successfully validating the first authentication message and responds to the first authentication message by sending the second authentication message via the network interface 740.

In some embodiments, the first authentication message contains a first sequence number (i.e., “SEQ”) and a first message authentication code, where the processor 705 uses the first message authentication code to authenticate the remote unit. In some embodiments, the first username comprises a key identifier for a reauthentication root key (i.e., “rRK”). In certain embodiments, the processor 705 generates a fresh session key in response to validating the first authentication message, where the fresh session key is derived using at least the rRK and a trusted non-3GPP access code as input to key derivation.

In some embodiments, the processor 705 determines whether a reauthentication integrity key (i.e., “rIK”) is stored in local memory. In certain embodiments, the processor 705 derives a fresh rIK using at least the rRK, the KM-DN, and the received SEQ number in response to the rIK not being stored in local memory or received a different SEQ of higher value than the locally stored SEQ, where the fresh rIK is used to authenticate the first message authentication code. In certain embodiments, the second authentication message contains a second message authentication code derived using the fresh rIK, where the remote unit uses the second message authentication code to authenticate the second apparatus.

In some embodiments, the first authentication message is received from a gateway function serving the remote unit. In such embodiments, the second authentication message comprises a reauthentication security context and is sent to the gateway function. In certain embodiments, the reauthentication security context contains the rRK, the rIK, the SEQ, and a rRK lifetime parameter. In other embodiments, the first authentication message is received from an access point serving the remote unit. In such embodiments, the second authentication message is sent to the remote unit via the serving access point.

In some embodiments, the processor 705 receives a registration request from the remote unit, the registration request indicating that the remote unit supports an ERP. In such embodiments, the processor 705 sends a gateway identifier and the KM-DN to the remote unit during a registration procedure for the remote unit.

In various embodiments, the processor 705 controls the network equipment apparatus 700 to implement the above described TNGF-2 behaviors. In such embodiments, the processor 705 receives a first authentication message for reauthenticating a remote unit (i.e., UE), where the first authentication message includes a Keyname-NAI comprising a first username (e.g., Keyname or other key identifier) and a first domain name. Here, the first domain name identifies a KM-DN and an associated gateway function holding a reauthentication security context. The processor 705 verifies the first domain name and determines from the NAI (e.g., from TNGF identification information indicated as part of the first domain name and the first username) that the reauthentication security context for the remote unit is held by a source gateway function (i.e., TNGF-1). The processor 705 forwards the first authentication message to the source gateway function based on associated gateway function contact information available as part of the first domain name and receives the reauthentication security context from the source gateway function. The processor 705 generates a second authentication message in response to receiving the reauthentication security context and sends the second authentication message to the remote unit.

In some embodiments, the processor 705 updates the NAI (e.g., a domain name portion of the Keyname-NAI) to point to the apparatus in response to receiving the reauthentication security context, where the second authentication message comprises the updated NAI. In some embodiments, the first username comprises a key identifier for a reauthentication root key (i.e., “rRK”), where the processor 705 generates a fresh session key in response to receiving the reauthentication security context, and where the fresh session key is derived using at least the rRK and a trusted non-3GPP access code as input to key derivation.

In some embodiments, the second authentication message contains a message authentication code derived using the reauthentication security context, where the remote unit uses the second message authentication code to authenticate the apparatus. In some embodiments, the reauthentication security context comprises the rRK, a fresh reauthentication integrity key (i.e., “rIK”), a sequence number (i.e., “SEQ”), and a reauthentication root key lifetime parameter.

In various embodiments, the processor 705 controls the network equipment apparatus 700 to implement the above described TNAP behaviors. In some embodiments, the processor 705 receives a first KM-DN from a gateway function during association between an access point and the gateway function, the first KM-DN forwarded to a remote unit (i.e., UE) for use in reauthentication. The processor 705 receives a first authentication message for reauthenticating the remote unit. In one embodiment, the first authentication message includes a KM-DN mismatch indictor. In another embodiment, the first authentication message includes an NAI (i.e., Keyname-NAI) comprising a first username and a first domain name, where the first domain name identifies a second KM-DN and an associated gateway function holding a reauthentication security context of the remote unit.

The processor 705 determines a KM-DN mismatch based on the first authentication message. In some embodiments, the processor 705 determining the KM-DN mismatch comprises identifying that the first authentication message includes the KM-DN mismatch indicator. In other embodiments, the processor 705 determines the KM-DN mismatch by examining the Keyname-NAI and identifying that the second KM-DN does not match the first KM-DN.

The processor 705 rejects reauthentication of the remote unit in response to the determined mismatch and triggers initial authentication with the remote unit in response to the rejected reauthentication.

The memory 710, in one embodiment, is a computer-readable storage medium. In some embodiments, the memory 710 includes volatile computer storage media. For example, the memory 710 may include a RAM, including DRAM, SDRAM, and/or SRAM. In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data relating to supporting remote unit (e.g., UE) reauthentication, for example storing security keys, IP addresses, UE contexts, and the like. In certain embodiments, the memory 710 also stores program code and related data, such as an OS or other controller algorithms operating on the network equipment apparatus 700 and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, may include any known electronically controllable display or display device. The output device 720 may be designed to output visual, audible, and/or haptic signals. In some embodiments, the output device 720 includes an electronic display capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, all or portions of the output device 720 may be located near the input device 715.

As discussed above, the transceiver 725 may communicate with one or more remote units and/or with one or more interworking functions that provide access to one or more PLMNs. The transceiver 725 may also communicate with one or more network functions (e.g., in the mobile core network 140). The transceiver 725 operates under the control of the processor 705 to transmit messages, data, and other signals and also to receive messages, data, and other signals. For example, the processor 705 may selectively activate the transceiver (or portions thereof) at particular times in order to send and receive messages.

The transceiver 725 may include one or more transmitters 730 and one or more receivers 735. In certain embodiments, the one or more transmitters 730 and/or the one or more receivers 735 may share transceiver hardware and/or circuitry. For example, the one or more transmitters 730 and/or the one or more receivers 735 may share antenna(s), antenna tuner(s), amplifier(s), filter(s), oscillator(s), mixer(s), modulator/demodulator(s), power supply, and the like. In one embodiment, the transceiver 725 implements multiple logical transceivers using different communication protocols or protocol stacks, while using common physical hardware.

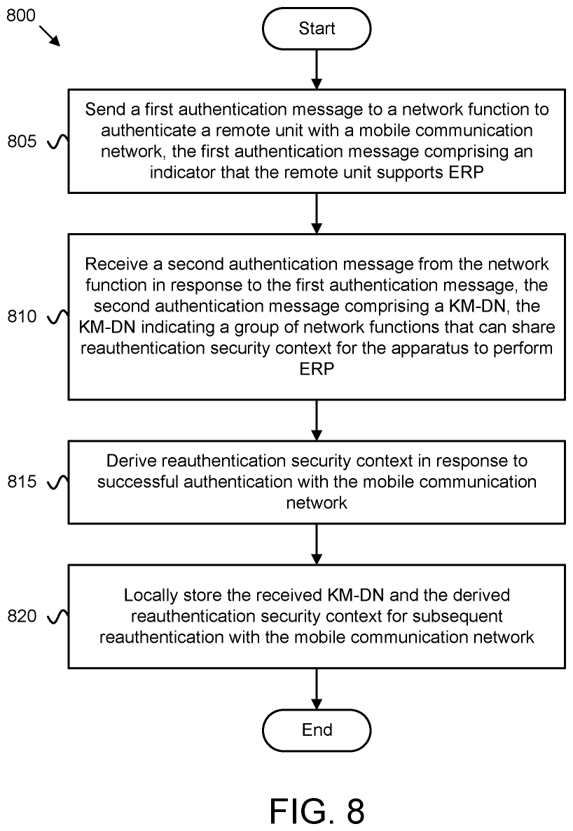

FIG. 8 depicts one embodiment of a method 800 for supporting remote unit (e.g., UE) reauthentication, according to embodiments of the disclosure. In various embodiments, the method 800 is performed by a UE, such as the remote unit 105, the UE 205 and/or the user equipment apparatus 600, described above. In some embodiments, the method 800 is performed by a processor, such as a microcontroller, a microprocessor, a CPU, a GPU, an auxiliary processing unit, a FPGA, or the like.

The method 800 begins and sends 805 a first authentication message to a network function to authenticate a remote unit (e.g., a UE) with a mobile communication network, the first authentication message containing an indicator that the remote unit supports ERP. The method 800 includes receiving 810 a second authentication message from the network function in response to the first authentication message, where the second authentication message contains a KM-DN, the KM-DN indicating a group of network functions that can share reauthentication security context for the apparatus to perform ERP.

The method 800 includes deriving 815 reauthentication security context in response to successful authentication with the mobile communication network. The method 800 includes locally storing 820 the received KM-DN and the derived reauthentication security context for subsequent reauthentication with the mobile communication network. The method 800 ends.

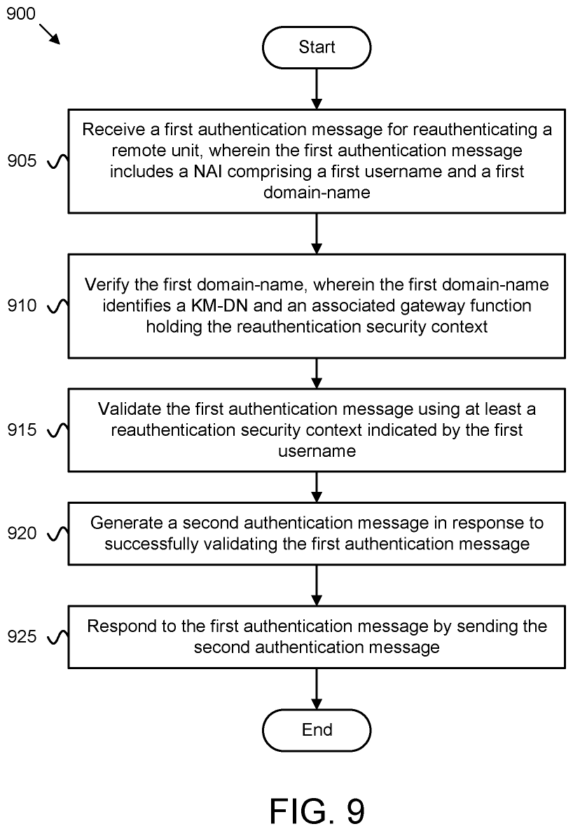

FIG. 9 depicts one embodiment of a method 900 for supporting remote unit (e.g., UE) reauthentication, according to embodiments of the disclosure. In various embodiments, the method 900 is performed by a TNGF, such as the TNGF-1 115, the TNGF-2 117, the TNGF 213, the TNGF-1 401, and/or the network equipment apparatus 700, described above. In some embodiments, the method 900 is performed by a processor, such as a microcontroller, a microprocessor, a CPU, a GPU, an auxiliary processing unit, a FPGA, or the like.

The method 900 begins and receives 905 a first authentication message for reauthenticating a remote unit (e.g., a UE), where the first authentication message includes an NAI containing a first username and a first domain name. The method 900 includes validating 910 the first domain name, where the first domain name identifies a KM-DN and an associated gateway function holding the reauthentication security context.

The method 900 includes validating 915 the first authentication message using at least a reauthentication security context indicated by the first username. The method 900 includes generating 920 a second authentication message in response to successfully validating the first authentication message. The method 900 includes responding 925 to the first authentication message by sending the second authentication message. The method 900 ends.

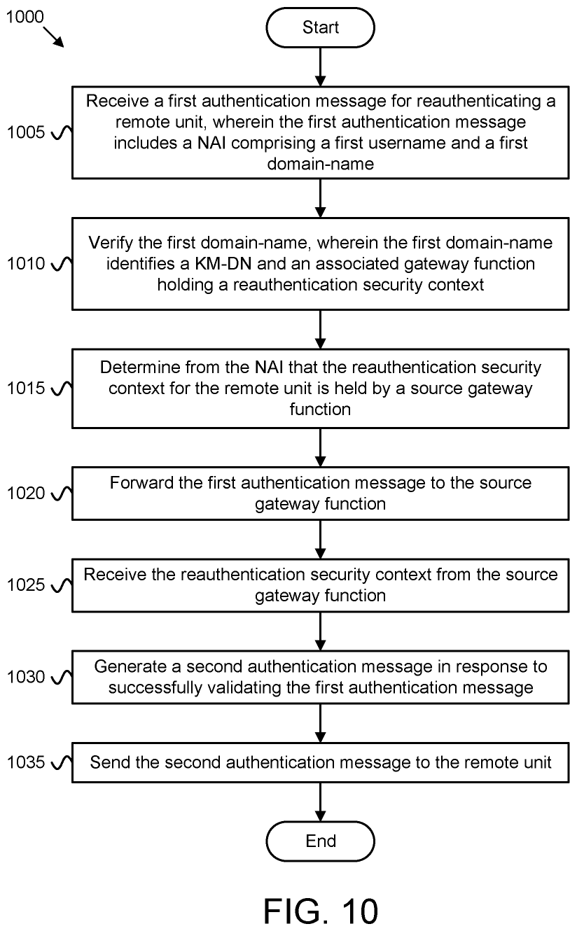

FIG. 10 depicts one embodiment of a method 1000 for supporting remote unit (e.g., UE) reauthentication, according to embodiments of the disclosure. In various embodiments, the method 1000 is performed by a target TNGF, such as the TNGF-2 117, the TNGF-2 403, and/or the network equipment apparatus 700, described above. In some embodiments, the method 1000 is performed by a processor, such as a microcontroller, a microprocessor, a CPU, a GPU, an auxiliary processing unit, a FPGA, or the like.

The method 1000 begins and receives 1005 a first authentication message for reauthenticating a remote unit (e.g., a UE), where the first authentication message includes an NAI containing a first username and a first domain name. The method 1000 includes verifying 1010 the first domain name, where the first domain name identifies a KM-DN and an associated gateway function holding a reauthentication security context.

The method 1000 includes determining 1015 from the NAI that the reauthentication security context for the remote unit is held by a source gateway function. The method 1000 includes forwarding 1020 the first authentication message to the source gateway function. The method 1000 includes receiving 1025 the reauthentication security context from the source gateway function.

The method 1000 includes generating 1030 a second authentication message in response to receiving the reauthentication security context. The method 1000 includes sending 1035 the second authentication message to the remote unit. The method 1000 ends.

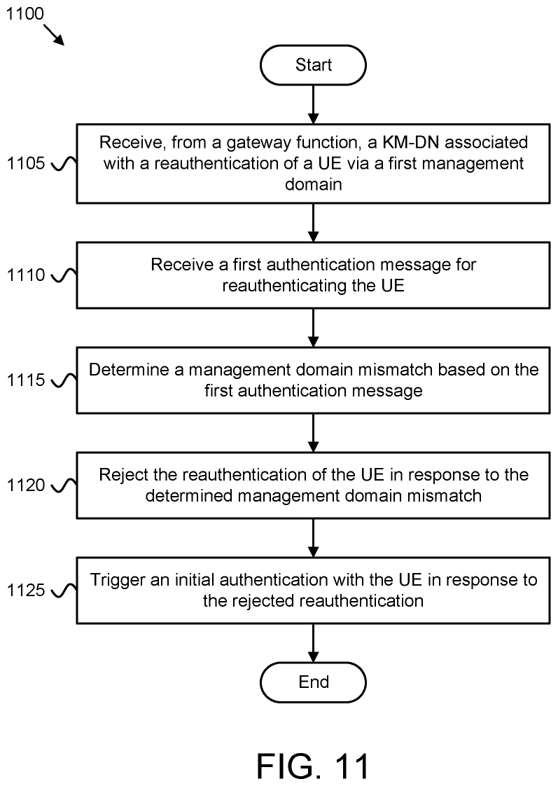

FIG. 11 depicts one embodiment of a method 1100 for supporting remote unit (e.g., UE) reauthentication, according to embodiments of the disclosure. In various embodiments, the method 1100 is performed by a non-3GPP access point, such as the base unit 121, the TNAP 211, the TNAP-2 303, and/or the network equipment apparatus 700, described above. In some embodiments, the method 1100 is performed by a processor, such as a microcontroller, a microprocessor, a CPU, a GPU, an auxiliary processing unit, a FPGA, or the like.

The method 1100 begins and receives 1105, from a gateway function, a KM-DN associated with a reauthentication of a UE via a first management domain. In some implementations, the KM-DN is received from the gateway function during association between the non-3GPP access point and the gateway function. In certain implementations, the non-3GPP access point may forward the KM-DN to the UE, e.g., for use in reauthentication.

The method 1100 includes receiving 1110 a first authentication message for reauthenticating the UE. In some implementations, the first authentication message may include a either a Key management domain name mismatch indicator and/or an NAI containing a first username and a first domain name. In certain implementations, the first domain name identifies a second KM-DN and an associated gateway function holding a reauthentication security context of the UE.

The method 1100 includes determining 1115 a management domain mismatch based on the first authentication message. The method 1100 includes rejecting 1120 the reauthentication of the UE in response to the determined management domain mismatch. The method 1100 includes triggering 1125 an initial authentication with the UE in response to the rejected reauthentication. The method 1100 ends.

Disclosed herein is a first apparatus for supporting UE reauthentication, according to embodiments of the disclosure. The first apparatus may be implemented by a UE, such as the remote unit 105, the UE 205 and/or the user equipment apparatus 600. The first apparatus includes a transceiver that communicates with a mobile communication network using a trusted non-3GPP access network TNAN and a processor that sends a first authentication message to a network function to authenticate with the mobile communication network, the first authentication message containing an indicator that the apparatus supports ERP. Via the transceiver, the processor receives a second authentication message from the network function in response to the first authentication message, where the second authentication message contains a KM-DN, the KM-DN indicating a group of network functions that can share reauthentication security context for the apparatus to perform ERP. In response to successful authentication with the mobile communication network, the processor derives reauthentication security context and locally stores the received KM-DN and the derived reauthentication security context for subsequent reauthentication with the mobile communication network.

In some embodiments of the first apparatus, the network function comprises a gateway function of the mobile communication network, the gateway function fetching reauthentication security context for subsequent reauthentication of the apparatus in response to the first authentication message including the ERP indicator.

In some embodiments of the first apparatus, the derived reauthentication security context comprises a reauthentication root key (i.e., “rRK”) and a key identifier for the rRK. In one embodiment, the rRK is derived using a key derivation function based on an EMSK, a SUPI, and a serving network name/home network ID. In another embodiment, the rRK is derived using a key derivation function based on an AUSF key (i.e., K_{AUSF}), the SUPI, and the serving network name/home network ID.

In certain embodiments of the first apparatus, in response to deriving the rRK based on the EMSK, a key identifier for the rRK (i.e., “EMSKname”) is derived using a key derivation function based on at least a SUPI and a serving network name/home network ID. In certain embodiments, in response to deriving the rRK based on the AUSF key (i.e., K_{AUSF}) a key identifier for the rRK (i.e., “Kausfname”) is derived using a key derivation function based on a SUPI, a serving network name/home network ID, and the AUSF key (i.e., K_{AUSF}), where Kausfname is used for subsequent reauthentication procedures.

In some embodiments of the first apparatus, the processor further receives a third authentication message from a new access point of the mobile communication network in response to the apparatus connecting to the new access point in the TNAN, the third authentication message comprising a second KM-DN.

In certain embodiments of the first apparatus, the processor further derives a fresh reauthentication integrity key (i.e., “rIK”) for securely exchanging and verifying ERP messages with the network function, the rIK derived at least in part from the KM-DN and a sequence number (i.e., “SEQ”). In such embodiments, the processor may further increment a received SEQ prior to using the SEQ to derive the fresh rIK.

In certain embodiments of the first apparatus, the processor further verifies whether the second KM-DN matches the locally stored KM-DN associated with the reauthentication security context. In such embodiments, the processor, in response to verifying that the second KM-DN matches the locally stored KM-DN, further generates an NAI and sends a fourth authentication message comprising the NAI to the new access point, the generated NAI stored locally at the apparatus for subsequent reference.

In certain embodiments of the first apparatus, the NAI of the form Keyname-NAI is generated based on a key identifier for an rRK (i.e., “EMSKname”) and a domain name, the domain name generated using an identifier for a previously authenticated network gateway function in the TNAN and the KM-DN such that the NAI has a form of “EMSKname@Domain-name.”

In some embodiments of the first apparatus, the processor further receives a fifth authentication message comprising an updated NAI from the new access point and verifies that the domain name for the updated NAI matches the locally stored domain name. In certain embodiments, the processor further, in response to verifying that the domain name for the updated NAI matches the locally stored domain name, deletes the current locally stored domain name, and locally stores the updated domain name and reauthentication security context.

In some embodiments of the first apparatus, the processor, in response to verifying that the received KM-DN fails to match the locally stored KM-DN, sends a domain mismatch indicator to the new access point in an EAP-Initiate/RE-auth message to trigger initial EAP full authentication for the apparatus.

Disclosed herein is a first method for supporting UE reauthentication, according to embodiments of the disclosure. The first method may be performed by a UE, such as the remote unit 105, the UE 205 and/or the user equipment apparatus 600. The first method includes sending a first authentication message to a network function to authenticate the UE with a mobile communication network and receiving a second authentication message from the network function in response to the first authentication message. Here, the first authentication message contains an indicator that the UE supports ERP, and the second authentication message contains a KM-DN, the KM-DN indicating a group of network functions that can share reauthentication security context for the UE to perform ERP. The first method includes deriving reauthentication security context in response to successful authentication with the mobile communication network and locally storing the received KM-DN and the derived reauthentication security context for subsequent reauthentication with the mobile communication network.

In some embodiments of the first method, the network function comprises a gateway function of the mobile communication network, the gateway function fetching reauthentication security context for subsequent reauthentication of the apparatus in response to the first authentication message including the ERP indicator.

In some embodiments of the first method, the derived reauthentication security context comprises a reauthentication root key (i.e., “rRK”) and a key identifier for the rRK. In one embodiment, the rRK is derived using a key derivation function based on an EMSK, a SUPI, and a serving network name/home network ID. In another embodiment, the rRK is derived using a key derivation function based on an AUSF key (i.e., K_{AUSF}), the SUPI, and the serving network name/home network ID.

In certain embodiments of the first method, in response to deriving the rRK based on the EMSK, a key identifier for the rRK (i.e., “EMSKname”) is derived using a key derivation function based on at least a SUPI and a serving network name/home network ID. In certain embodiments, in response to deriving the rRK based on the AUSF key (i.e., K_{AUSF}), a key identifier for the rRK (i.e., “Kausfname”) is derived using a key derivation function based on a SUPI, a serving network name/home network ID, and the AUSF key (i.e., K_{AUSF}), where Kausfname is used for subsequent reauthentication procedures.

In some embodiments, the first method further includes receiving a third authentication message from a new access point of the mobile communication network in response to the apparatus connecting to the new access point in the TNAN, the third authentication message comprising a second KM-DN.

In certain embodiments, the first method further includes deriving a fresh reauthentication integrity key (i.e., “rIK”) for securely exchanging and verifying ERP messages with the network function, the rIK derived at least in part from the KM-DN and a sequence number (i.e., “SEQ”). In such embodiments, the first method may further include incrementing a received SEQ prior to using the SEQ to derive the fresh rIK.

In certain embodiments, the first method further includes verifying whether the second KM-DN matches the locally stored KM-DN associated with the reauthentication security context. In such embodiments, in response to verifying that the second KM-DN matches the locally stored KM-DN, the first method further includes generating an NAI and sends a fourth authentication message comprising the NAI to the new access point, the generated NAI stored locally at the apparatus for subsequent reference.

In certain embodiments of the first method, the NAI of the form Keyname-NAI is generated based on a key identifier for an rRK (i.e., “EMSKname”) and a domain name, the domain name generated using an identifier for a previously authenticated network gateway function in the TNAN and the KM-DN such that the NAI has a form of “EMSKname@Domain-name.”

In some embodiments, the first method further includes receiving a fifth authentication message comprising an updated NAI from the new access point and verifying that the domain name for the updated NAI matches the locally stored domain name. In certain embodiments, in response to verifying that the domain name for the updated NAI matches the locally stored domain name, the first method includes deleting the current locally stored domain name and locally storing the updated domain name and reauthentication security context.

In some embodiments, the first method includes sending a domain mismatch indicator to the new access point in an EAP-Initiate/RE-auth message to trigger initial EAP full authentication for the UE in response to verifying that the received KM-DN fails to match the locally stored KM-DN.

Disclosed herein is a second apparatus for supporting UE reauthentication, according to embodiments of the disclosure. The second apparatus may be implemented by a TNGF, such as the TNGF-1 115, the TNGF-2 117, the TNGF 213, the TNGF-1 401, and/or the network equipment apparatus 700. The second apparatus includes a network interface that communicates with a mobile communication network and a processor that receives a first authentication message for reauthenticating a UE (e.g., a remote unit), where the first authentication message includes an NAI comprising a first username and a first domain name. The processor verifies the first domain name and validates the first authentication message using at least a reauthentication security context indicated by the first username. Here, the first domain name identifies a KM-DN and an associated gateway function holding the reauthentication security context. The processor generates a second authentication message in response to successfully validating the first authentication message and responds to the first authentication message by sending the second authentication message via the network interface.

In some embodiments of the second apparatus, the first authentication message contains a first sequence number (i.e., “SEQ”) and a first message authentication code, where the processor uses the first message authentication code to authenticate the UE. In some embodiments, the first username comprises a key identifier for a reauthentication root key (i.e., “rRK”). In certain embodiments, the processor generates a fresh session key in response to validating the first authentication message, where the fresh session key is derived using at least the rRK and a trusted non-3GPP access code as input to key derivation.

In some embodiments of the second apparatus, the processor determines whether a reauthentication integrity key (i.e., “rIK”) is stored in local memory. In certain embodiments, the processor derives a fresh rIK using at least the rRK, the KM-DN, and the received SEQ number in response to the rIK not being stored in local memory or received a different SEQ of higher value than the locally stored SEQ, where the fresh rIK is used to authenticate the first message authentication code. In certain embodiments, the second authentication message contains a second message authentication code derived using the fresh rIK, where the UE uses the second message authentication code to authenticate the second apparatus.

In some embodiments of the second apparatus, the first authentication message is received from a gateway function serving the UE. In such embodiments, the second authentication message comprises a reauthentication security context and is sent to the gateway function. In certain embodiments, the reauthentication security context contains the rRK, the rIK, the SEQ, and a rRK lifetime parameter. In other embodiments, the first authentication message is received from an access point serving the UE. In such embodiments, the second authentication message is sent to the UE via the serving access point.

In some embodiments of the second apparatus, the processor receives a registration request from the UE, the registration request indicating that the UE supports an ERP. In such embodiments, the processor sends a gateway identifier and the KM-DN to the UE during a registration procedure for the UE.

Disclosed herein is a second method for supporting UE reauthentication, according to embodiments of the disclosure. The second method may be implemented by a TNGF, such as the TNGF-1 115, the TNGF-2 117, the TNGF 213, the TNGF-1 401, and/or the network equipment apparatus 700. The second method includes receiving a first authentication message for reauthenticating a UE (e.g., a remote unit). Here, the first authentication message includes an NAI containing a first username and a first domain name. The second method includes verifying the first domain name and validating the first authentication message using at least a reauthentication security context indicated by the first username. Here, the first domain name identifies a KM-DN and an associated gateway function holding the reauthentication security context. The second method includes generating a second authentication message in response to successfully validating the first authentication message and responding to the first authentication message by sending the second authentication message.

In some embodiments of the second method, the first authentication message contains a first sequence number (i.e., “SEQ”) and a first message authentication code, where TNGF uses the first message authentication code to authenticate the UE. In some embodiments, the first username comprises a key identifier for a reauthentication root key (i.e., “rRK”). In certain embodiments, the second method further includes generating a fresh session key in response to validating the first authentication message, where the fresh session key is derived using at least the rRK and a trusted non-3GPP access code as input to key derivation.

In some embodiments, the second method includes determining whether a reauthentication integrity key (i.e., “rIK”) is stored in local memory. In certain embodiments, the second method further includes deriving a fresh rIK using at least the rRK, the KM-DN, and the received SEQ number in response to the rIK not being stored in local memory or received a different SEQ of higher value than the locally stored SEQ, where the fresh rIK is used to authenticate the first message authentication code. In certain embodiments, the second authentication message contains a second message authentication code derived using the fresh rIK, where the UE uses the second message authentication code to authenticate the TNGF.

In some embodiments of the second method, the first authentication message is received from a gateway function serving the UE. In such embodiments, the second authentication message comprises a reauthentication security context and is sent to the gateway function. In certain embodiments, the reauthentication security context contains the rRK, the rIK, the SEQ, and a rRK lifetime parameter. In other embodiments, the first authentication message is received from an access point serving the UE. In such embodiments, the second authentication message is sent to the UE via the serving access point.

In some embodiments, the second method further includes receiving a registration request from the UE, the registration request indicating that the UE supports an ERP. In such embodiments, the second method further includes sending a gateway identifier and the KM-DN to the UE during a registration procedure for the UE.

Disclosed herein is a third apparatus for supporting UE reauthentication, according to embodiments of the disclosure. The third apparatus may be implemented by a target TNGF, such as the TNGF-2 117, the TNGF-2 403, and/or the network equipment apparatus 700. The third apparatus includes a network interface that communicates with a mobile communication network and a processor that receives a first authentication message for reauthenticating a UE (e.g., a remote unit), where the first authentication message includes an NAI comprising a first username and a first domain name. The processor verifies the first domain name and determines from the NAI that the reauthentication security context for the UE is held by a source gateway function. Here, the first domain name identifies a KM-DN and an associated gateway function holding a reauthentication security context. The processor forwards the first authentication message to the source gateway function and receives the reauthentication security context from the source gateway function. The processor generates a second authentication message in response to receiving the reauthentication security context and sends the second authentication message to the UE.

In some embodiments of the third apparatus, the processor updates the NAI to point to the apparatus in response to receiving the reauthentication security context, where the second authentication message comprises the updated NAI. In some embodiments, the first username comprises a key identifier for a reauthentication root key (i.e., “rRK”), where the processor generates a fresh session key in response to receiving the reauthentication security context, and where the fresh session key is derived using at least the rRK and a trusted non-3GPP access code as input to key derivation.

In some embodiments of the third apparatus, the second authentication message contains a message authentication code derived using the reauthentication security context, where the UE uses the second message authentication code to authenticate the apparatus. In some embodiments, the reauthentication security context comprises the rRK, a fresh reauthentication integrity key (i.e., “rIK”), a sequence number (i.e., “SEQ”), and a reauthentication root key lifetime parameter.

Disclosed herein is a third method for supporting UE reauthentication, according to embodiments of the disclosure. The third method may be implemented by a target TNGF, such as the TNGF-2 117, the TNGF-2 403, and/or the network equipment apparatus 700. The third method includes receiving a first authentication message for reauthenticating a UE (e.g., a remote unit). Here, the first authentication message includes an NAI containing a first username and a first domain name. The third method includes verifying the first domain name and determining from the NAI that the reauthentication security context for the UE is held by a source gateway function. Here, the first domain name identifies a KM-DN and an associated gateway function holding a reauthentication security context. The third method includes forwarding the first authentication message to the source gateway function and receiving the reauthentication security context from the source gateway function. The third method includes generating a second authentication message in response to receiving the reauthentication security context and sending the second authentication message to the UE.

In some embodiments, the third method includes updating the NAI to point to the apparatus in response to receiving the reauthentication security context, where the second authentication message comprises the updated NAI. In some embodiments, the first username comprises a key identifier for a reauthentication root key (i.e., “rRK”), where the third method includes generating a fresh session key in response to receiving the reauthentication security context, and where the fresh session key is derived using at least the rRK and a trusted non-3GPP access code as input to key derivation.

In some embodiments of the third method, the second authentication message contains a message authentication code derived using the reauthentication security context, where the UE uses the second message authentication code to authenticate the apparatus. In some embodiments, the reauthentication security context comprises the rRK, a fresh reauthentication integrity key (i.e., “rIK”), a sequence number (i.e., “SEQ”), and a reauthentication root key lifetime parameter.

Disclosed herein is a fourth apparatus for supporting UE reauthentication, according to embodiments of the disclosure. The fourth apparatus may be implemented by a non-3GPP access point, such as the base unit 121, the TNAP 211, the TNAP-2 303, and/or the network equipment apparatus 700. The fourth apparatus includes a transceiver for communicating with a UE (e.g., a remote unit) and a gateway function (e.g., a TNGF), and further includes a processor (e.g., coupled with at least one memory) configured to receive, from the gateway function, a KM-DN associated with a reauthentication of the UE via a first key management domain. The processor is configured to receive a first authentication message for reauthenticating the UE and to determine a management domain mismatch based on the first authentication message. The processor is configured to reject the reauthentication of the UE in response to the determined management domain mismatch and to trigger an initial authentication with the UE in response to the rejected reauthentication.

In some implementations of the fourth apparatus, the first authentication message includes a KM-DN mismatch indicator or an NAI associated with a second key management domain. In certain implementations, the NAI includes a username and a domain name that identifies the second key management domain, where the domain name further identifies a second gateway function holding a reauthentication security context of the UE.

In some implementations of the fourth apparatus, the KM-DN is received during an association procedure between the base station and the gateway function, where the KM-DN is forwarded to the UE for use in reauthentication. In some implementations, the KM-DN indicates a group of trusted access network nodes permitted to share a reauthentication security context of the UE.

In some implementations of the fourth apparatus, the processor is configured to cause the fourth apparatus to receive, from the gateway function, a second authentication message comprising a success packet in response to the initial authentication with the UE, and to transmit the success packet to the UE. In certain implementations, the second authentication message may include an access point security key and the KM-DN. In such implementations, the processor may be configured to cause the fourth apparatus to derive a set of security keys based on the access point security key, and to establish a security association with the UE for protecting subsequent traffic.

Disclosed herein is a fourth method for supporting UE reauthentication, according to embodiments of the disclosure. The fourth method may be implemented by a non-3GPP access point, such as the base unit 121, the TNAP 211, the TNAP-2 303, and/or the network equipment apparatus 700. The fourth method includes receiving, from a gateway function, a KM-DN associated with a reauthentication of a UE via a first key management domain. The fourth method includes receiving a first authentication message for reauthenticating the UE and determining a management domain mismatch based on the first authentication message. The fourth method includes rejecting the reauthentication of the UE in response to the determined management domain mismatch and triggering an initial authentication with the UE in response to the rejected reauthentication.

In some implementations of the fourth method, the first authentication message includes a KM-DN mismatch indicator or an NAI associated with a second key management domain. In certain implementations, the NAI comprises a username and a domain name that identifies the second key management domain, and wherein the domain name further identifies a second gateway function holding a reauthentication security context of the UE.

In some implementations of the fourth method, the KM-DN is received during an association procedure between the base station and the gateway function, and wherein the KM-DN is forwarded to the UE for use in reauthentication. In some implementations, the KM-DN indicates a group of trusted access network nodes permitted to share a reauthentication security context of the UE.

In some implementations, the fourth method further includes receiving, from the gateway function, a second authentication message comprising a success packet in response to the initial authentication with the UE and transmitting the success packet to the UE. In certain implementations, the second authentication message comprises an access point security key and the KM-DN. In such implementations, the fourth method may further include deriving a set of security keys based on the access point security key and establishing a security association with the UE for protecting subsequent traffic.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A base station for wireless communication, comprising:
at least one memory; and
at least one processor coupled with the at least one memory and configured to cause the base station to:
receive, from a gateway function, a key management domain name associated with a reauthentication of a user equipment (UE) via a first key management domain;
receive a first authentication message for reauthenticating the UE;
determine a management domain mismatch based on the first authentication message;
reject the reauthentication of the UE in response to the determined management domain mismatch; and
trigger an initial authentication with the UE in response to the rejected reauthentication.

2. The base station of claim 1, wherein the first authentication message includes a key management domain name mismatch indicator or a network access identifier (NAI) associated with a second key management domain.

3. The base station of claim 2, wherein the NAI comprises a username and a domain name that identifies the second key management domain, and wherein the domain name further identifies a second gateway function holding a reauthentication security context of the UE.

4. The base station of claim 1, wherein the key management domain name is received during an association procedure between the base station and the gateway function, and wherein the key management domain name is forwarded to the UE for use in reauthentication.

5. The base station of claim 1, wherein the key management domain name indicates a group of trusted access network nodes permitted to share a reauthentication security context of the UE.

6. The base station of claim 1, wherein the at least one processor is configured to cause the base station to:
receive, from the gateway function, a second authentication message comprising a success packet in response to the initial authentication with the UE; and
transmit the success packet to the UE.

7. The base station of claim 6, wherein the second authentication message comprises an access point security key and the key management domain name, and wherein the at least one processor is configured to cause the base station to:
derive a set of security keys based on the access point security key; and
establish a security association with the UE for protecting subsequent traffic.

8. A method performed by a base station, the method comprising:
receiving, from a gateway function, a key management domain name associated with a reauthentication of a user equipment (UE) via a first key management domain;
receiving a first authentication message for reauthenticating the UE;
determining a management domain mismatch based on the first authentication message;
rejecting the reauthentication of the UE in response to the determined management domain mismatch; and
triggering an initial authentication with the UE in response to the rejected reauthentication.

9. The method of claim 8, wherein the first authentication message includes a key management domain name mismatch indicator or a network access identifier (NAI) associated with a second key management domain.

10. The method of claim 9, wherein the NAI comprises a username and a domain name that identifies the second key management domain, and wherein the domain name further identifies a second gateway function holding a reauthentication security context of the UE.

11. The method of claim 8, wherein the key management domain name is received during an association procedure between the base station and the gateway function, and wherein the key management domain name is forwarded to the UE for use in reauthentication.

12. The method of claim 8, wherein the key management domain name indicates a group of trusted access network nodes permitted to share a reauthentication security context of the UE.

13. The method of claim 8, further comprising:
receiving, from the gateway function, a second authentication message comprising a success packet in response to the initial authentication with the UE; and
transmitting the success packet to the UE.

14. The method of claim 13, wherein the second authentication message comprises an access point security key and the key management domain name, and wherein the method further comprises:
deriving a set of security keys based on the access point security key; and
establishing a security association with the UE for protecting subsequent traffic.

15. A processor for wireless communication, comprising:
at least one controller coupled with at least one memory and configured to cause the processor to:
receive, from a gateway function, a key management domain name associated with a reauthentication of a user equipment (UE) via a first key management domain;
receive a first authentication message for reauthenticating the UE;
determine a management domain mismatch based on the first authentication message;
reject the reauthentication of the UE in response to the determined management domain mismatch; and
trigger an initial authentication with the UE in response to the rejected reauthentication.

16. The processor of claim 15, wherein the first authentication message includes a key management domain name mismatch indicator or a network access identifier (NAI) associated with a second key management domain.

17. The processor of claim 16, wherein the NAI comprises a username and a domain name that identifies the second key management domain, and wherein the domain name further identifies a second gateway function holding a reauthentication security context of the UE.

18. The processor of claim 15, wherein the key management domain name is received during an association procedure between a base station and the gateway function, and wherein the key management domain name is forwarded to the UE for use in reauthentication.

19. The processor of claim 15, wherein the key management domain name indicates a group of trusted access network nodes permitted to share a reauthentication security context of the UE.

20. The processor of claim 15, wherein the at least one controller is configured to cause the processor to:
receive, from the gateway function, a second authentication message comprising a success packet in response to the initial authentication with the UE; and
transmit the success packet to the UE.
